(19) United States
(12) Patent Application Publication
(10) Pub. No.: US 2007/0293398 A1
(43) Pub. Date: Dec. 20, 2007

(54) Method for Controlling Coniferous Plants

(75) Inventors: Cletus Youmans, Dyersburg, TN (US); Harold E. Quicke, Auburn, AL (US); Joseph Zawierucha, Cary, NC (US); Larry J. Newsom, Holly Springs, NC (US)

Correspondence Address: ROTHWELL, FIGG, ERNST & MANBECK, P.C., 1425 K STREET, N.W., SUITE 800, WASHINGTON, DC, 20005, US

(73) Assignee: BASF Aktiengesellschaft, Ludwigshafen (DE)

(21) Appl. No.: 11/631,890

(22) PCT Filed: Jul. 6, 2005
(86) PCT No.: PCT/EP05/07275

§ 371 Date: Jul. 10, 2007

Related U.S. Application Data
(60) Provisional application No. 60/586,213, filed on Jul. 9, 2004.

(51) Int. Cl. A01N 43/64; A01N 43/40; A01N 43/46; A01N 57/20; A01N 43/48

(52) U.S. Cl. 504/127; 504/129; 504/130; 504/134; 504/136; 504/142

(57) ABSTRACT

A method for controlling coniferous plants, wherein an effective amount of
a) at least one phenyluracil of the formula I 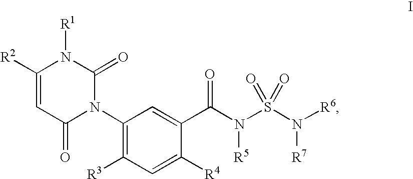
wherein the variables R¹ to R⁷ are as defined in the specification; and optionally b) at least one herbicide B selected from groups B1 to B6 as defined in the specification, and/or at least one of the agriculturally acceptable salts of herbicide B or their agriculturally acceptable derivatives, provided they have a carboxyl group, is applied to coniferous plants to be controlled and/or to the parts of these plants, is described.

The present invention relates to a method for controlling coniferous plants, in particular naturally seeded conifer plants (wildling conifer) and especially for controlling wildling pine, i.e. naturally seeded pine plants.

The control of naturally seeded coniferous plants (wildling conifer control) has become an important issue in forestry. In conifer plantations and especially in pine plantations naturally seeded coniferous plants (wildlings) compete with planted ones. However, these wildlings are genetically inferior and result in sub-optimal stand density.

It is expected that the problem of wildling conifers will increase in the future for the following reasons: the use of fire to control wildling conifers in site preparation has been severely restricted by the government, the use of mechanical site preparation has diminished; the adoption of intensive management including vegetation control, fertilization and thinning is increasing the number of wild germinants and seedlings in existing stands and after harvest; with small harvesting areas becoming increasingly common, overseedings from neighbouring stands and overstocking of young plantations become more prevalent. Therefore, forest managers need a treatment that controls these unwanted wildling seedlings and releases genetically improved, newly planted conifer seedlings with no or marginal damage.

The major compounds currently used for wildling conifer control in conifer plantations include glyphosate and fosamine. Both compounds require high application rates. Moreover, lack of consistency in control is an issue with glyphosate.

J. L. Yeiser reported in Proc. South. Weed Sci. Soc. 2000, vol. 53, pp 133 to 137 about the use of commercial bromacil/diuron mixtures and of azafenidin in wildling pine control. However, the achieved control was only similar to control achieved by sulfometuron-methyl, which is used in forestry for conventional weed control. Same author reported in Proc. South. Weed Sci. Soc. 2001, vol. 54, pp. 94 to 98 about investigations on wildling pine control by combined pre- and post-emergence treatments with sulfometuron-methyl, fosamine, azafenidin and azafenidin/sulfometuron-methyl mixtures. However, control of pine germinants by these methods was inadequate.

Therefore, it is an objective of the present invention to provide a method for reliable and effective wildling conifer control. Moreover, this method should release newly planted conifer seedlings without or with only slight damaging.

Surprisingly, it was found that this objective could be achieved by a method for controlling coniferous plants, wherein an effective amount of
a) at least one phenyluracil of formula I 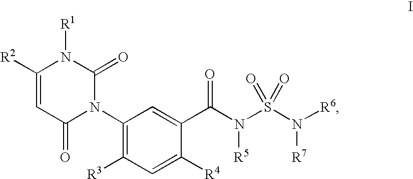
   wherein the variables R¹ to R⁷ are as defined below:

R¹ is methyl or NH₂;

R² is C₁-C₂-haloalkyl;

R³ is hydrogen or halogen;

R⁴ is halogen or cyano;

R⁵ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or C₁-C₆-alkyl;

R⁶, R⁷ independently of one another are hydrogen, C₁-C₆-alkyl, C₃-C₆-alkenyl, C3-C₆-alkynyl, C₃-C₇-cycloalkyl, C₃-C₇-cycloalkenyl, C₁-C₆-alkoxy, phenyl or benzyl, where each of the 8 abovementioned substituents is unsubstituted or may be substituted by 1 to 6 halogen atoms and/or by one, two or three radicals selected from the group consisting of cyano, C₃-C₇-cycloalkyl, hydroxy, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, amino, C₁-C₄-alkylamino, di(C₁-C₄-alkyl)amino, formyl, C₁-C₄-alkylcarbonyl, C₁-C₄-alkoxycarbonyl, aminocarbonyl, C₁-C₄-alkylaminocarbonyl, di(C₁-C₄-alkyl)aminocarbonyl, phenyl and benzyl; or
R⁶, R⁷ together with the nitrogen atom form a 3-, 4-, 5-, 6- or 7-membered saturated or unsaturated nitrogen containing heterocycle which may be substituted by 1 to 6 methyl groups and which may contain 1 or 2 further heteroatoms selected from the group consisting of nitrogen, oxygen and sulfur as ring members; and/or at least one of its agriculturally acceptable salts; and optionally
b) at least one herbicide B selected from groups B1 to B6:
   B1 acetolactate synthase inhibitors (ALS inhibitors);
   B2 photosynthesis inhibitors;
   B3 enolpyruvyl shikimate 3-phosphate synthase inhibitors (EPSP inhibitors);
   B4 glutamine synthetase inhibitors;
   B5 auxin herbicides;
   B6 other herbicides: fosamine;
and/or at least one of the agriculturally acceptable salts of herbicide B or their agriculturally acceptable derivatives, provided they have a carboxyl group; is applied to coniferous plants to be controlled and/or to the parts of these plants.

This method provides for effective control of wildling conifers, in particular of wildlings that belong to the Pinaceae family and especially the control of wildling pine species (generally referred to as wildling pine control). Moreover, the present invention leads to a reduction of undesired weeds and thus facilitates the growth of the planted coniferous plants.

Therefore, the present invention provides a method for controlling coniferous plants, in particular naturally seeded coniferous plants (wildling conifers), wherein an effective amount of
a) at least one phenyluracil of formula I as defined above, and optionally
b) at least one herbicide B selected from groups B1 to B6 as defined above, is applied to the coniferous plants to be controlled or to their parts, such as roots, leaves, seeds or germinants.

The present invention furthermore provides a method for controlling other undesirable vegetation in forestry, in particular a range of woody species and herbaceous species.

Furthermore the method according to the present invention can also be used in coniferous plants which are resistant to one ore more herbicides owing to genetic engineering and/or breeding, or which are resistant to attack by insects owing to genetic engineering and/or breeding.

Phenyluracils of formula I and their agriculturally acceptable salts as well as their preparation are disclosed in the earlier patent application WO 01/83459. For further details about the preparation of phenyluracils of formula I reference is made to WO 01/83459, in particular to the preparation examples.

The herbicides B of groups B1 to B6 are known from literature; see, for example The Compendium of Pesticide Common Names (http://www.hclrss.demon.co.uk/ index.html); Crop Protection Handbook 2004 Vol. 90, Meister Media Worldwide, 2004; B. Hock, C. Fedtke, R. R. Schmidt, Herbizide, Georg Thieme Verlag, Stuttgart 1995; K. Vencill, Herbicide Handbook, 8^{th} Edition, Weed Science Society of America, 2002.

The categorization of the active compounds according to their mode of action is based on current understanding. If an active compound acts by more than one mode of action, this substance was assigned to only one mode of action.

Herbicidal mixtures based on 3-phenyluracils are known from earlier patent application WO 03/024221.

If the phenyluracils of formula I and/or the herbicides B are capable of forming geometrical isomers, for example E/Z isomers, it is possible to use both the pure isomers and mixtures thereof in the compositions according to the invention.

If the phenyluracils of formula I and/or the herbicides B have one or more centers of chirality and, as a consequence, are present as enantiomers or diastereomers, it is possible to use both the pure enantiomers and diastereomers and their mixtures in the compositions according to the invention.

If the phenyluracils of formula I and/or the herbicides B have functional groups which can be ionized, they may also be applied as their agriculturally acceptable salts as well as their agriculturally acceptable derivatives.

The agriculturally acceptable salts of the phenyluracil of formula I as well as the herbicide B comprise at least one agriculturally acceptable counterion. In general, the salts of those cations or the acid addition salts of those acids are suitable whose cations and anions, respectively, have no adverse effect on the action of the active compounds. Preferred cations are the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium in which one to four hydrogen atoms are replaced by C₁-C₄-alkyl, C₃-C₆-cycloalkyl, hydroxy-C₁-C₄-alkyl, C₁-C₄-alkoxy-C₁-C₄-alkyl, hydroxy-C₁-C₄-alkoxy-C₁-C₄-alkyl, C₁-C₄-alkoxy, phenyl or benzyl; preferably ammonium, methylammonium, isopropylammonium, dimethylammonium, diisopropylammonium, trimethylammonium, tetramethylammonium, tetraethylammo- nium, tetrabutylammonium, 2-hydroxyethylammonium, 2-(2-hydroxyethoxy)eth-1-ylammonium, di(2-hydroxyeth-1-yl)ammonium, benzyltrimethylammonium, benzyltriethylammonium; furthermore phosphonium ions, sulfonium ions, preferably tri(C₁-C₄-alkyl)sulfonium such as trimethylsulfonium; and sulfoxonium ions, preferably tri(C₁-C₄-alkyl)sulfoxonium.

It is possible to use, for example, the phenyluracil of formula I and amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, propoxycarbazon, flucarbazon, imazamethabenz, imazamox, imazapic, imazapyr, imazaquin, imazethapyr, cloransulam, diclosulam, florasulam, flumetsulam, metosulam, penoxsulam, bispyribac, pyrithiobac, pyriminobac, bentazon, glyphosate, glufosinate, bilanaphos, clomeprop, 2,4-D, 2,4-DB, dichlorprop, dichlorprop-P, MCPA, MCPB, mecoprop, mecoprop-P, 2,4,5-T, chloramben, dicamba, 2,3,6-TBA, tricamba, quinclorac, quinmerac, aminopyralid, clopyralid, fluroxypyr, picloram, triclopyr and fosamine, if desired, as salts of the agriculturally useful cations mentioned above, in the compositions according to the invention.

Anions of useful acid addition salts are primarily chloride, bromide, fluoride, iodide, hydrogen sulfate, methyl sulfate, sulfate, dihydrogen phosphate, hydrogen phosphate, nitrate, dicarbonate, carbonate, hexafluorosilicate, hexafluorophosphate, benzoate and the anions of C₁-C₄-alkanoic acids, preferably formate, acetate, propionate and butyrate.

It is also possible to use the active compounds which carry a carboxyl group in the form of their agriculturally acceptable derivative, for example as amides such as primary amides, mono- or di-C₁-C₆-alkylamides or arylamides, as esters, for example as allyl esters, propargyl esters, C₁-C₁₀-alkyl esters or alkoxyalkyl esters, and also as thioesters, for example as C₁-C₁₀-alkyl thioesters.

Examples of active compounds having a COOH group which can also be employed as derivatives are: bensulfuron, chlorimuron, ethametsulfuron, flupyrsulfuron, halosulfuron, iodosulfuron, mesosulfuron, metsulfuron, primisulfuron, pyrazosulfuron, sulfometuron, thifensulfuron, tribenuron, triflusulfuron, imazamethabenz, imazamox, imazapic, imazapyr, imazaquin, imazethapyr, cloransulam, bispyribac, pyrithiobac, pyriminobac, clomeprop, 2,4-D, 2,4-DB, dichlorprop, dichlorprop-P, MCPA, MCPB, mecoprop, mecoprop-P, 2,4,5-T, chloramben, dicamba, 2,3,6-TBA, tricamba, quinclorac, quinmerac, aminopyralid, clopyralid, fluroxypyr, picloram and triclopyr.

Preferred mono- and di-C₁-C₆-alkylamides are the methyl- and the dimethylamides. Preferred arylamides are, for example, the anilidines and the 2-chloroanilides. Preferred alkyl esters are, for example, the methyl, ethyl, propyl, isopropyl, butyl, isobutyl, pentyl, mexyl (1 -methylhexyl) or isooctyl (2-ethylhexyl) esters.

Preferred C₁-C₄-alkoxy-C₁-C₄-alkyl esters are the straight-chain or branched C₁-C₄-alkoxyethyl esters, for example the methoxyethyl, ethoxyethyl or butoxyethyl esters. An example of the straight-chain or branched C₁-C₁₀-alkyl thioesters is the ethyl thioester.

The organic moieties mentioned in the definition of the substituents R², R⁵, R⁶, R⁷ in the phenyluraclis of formula I or as radicals on cycloalkyl, phenyl or heterocyclic rings are—like the term halogen—collective terms for individual enumerations of the individual group members. All hydrocarbon chains, i.e. all alkyl, haloalkyl, cycloalkyl, alkoxy, haloalkoxy, alkylamino, alkylthio, haloalkylthio, alkylsulfinyl, haloalkylsulfinyl, alkylsulfonyl, haloalkylsulfonyl, alkenyl and alkynyl groups and corresponding moieties in larger groups such as alkylcarbonyl, alkylaminocarbonyl, dialkylaminocarbonyl, alkoxycarbonyl, etc., can be straight-chain or branched. The prefix Cₙ-Cₘ denoting in each case the possible number of carbon atoms in the group.

Halogenated substituents preferably carry one, two, three, four or five identical or different halogen atoms. The term halogen denotes in each case fluorine, chlorine, bromine or iodine.

Examples of other meanings are:
C₁-C₄-alkyl: CH₃, C₂H₅, n-propyl, CH(CH₃)₂, n-butyl, CH(CH₃)-C₂H₅, CH₂-CH(CH₃)₂ and C(CH₃)₃;
C₁-C₄-haloalkyl: a C₁-C₄-alkyl radical as mentioned above which is partially or fully substituted by fluorine, chlorine, bromine and/or iodine, i.e., for example, CH₂F, CHF₂, CF₃, CH₂Cl, dichloromethyl, trichloromethyl, chlorofluormethyl, dichlorofluoromethyl, chlorodifluoromethyl, 2-fluoroethyl, 2-chloroethyl, 2-bromoethyl, 2-iodoethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-tri-chloroethyl, C₂F₅, 2-fluoropropyl, 3-fluoropropyl, 2,2-difluoropropyl, 2,3-difluoro-propyl, 2-chloro-propyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chloroethyl, 1-(bromomethyl)-2-bromoethyl, 4-fluorobutyl, 4-chlorobutyl, 4-bromobutyl or nonafluorobutyl;
C₁-C₆-alkyl: C₁-C₄-alkyl as mentioned above, and also, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethyl-butyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, preferably methyl, ethyl, n-propyl, 1-methylethyl, n-butyl, 1,1-dimethylethyl, n-pentyl or n-hexyl;
C₁-C₆-haloalkyl: a C₁-C₆-alkyl radical as mentioned above which is partially or fully substituted by fluorine, chlorine, bromine and/or iodine, i.e., for example, one of the radicals mentioned under C₁-C₄-haloalkyl and also 5-fluoro-1-pentyl, 5-chloro-1-pentyl, 5-bromo-1-pentyl, 5-iodo-1-pentyl, 5,5,5-trichloro-1-pentyl, undecafluoropentyl, 6-fluoro-1-hexyl, 6-chloro-1-hexyl, 6-bromo-1-hexyl, 6-iodo-1-hexyl, 6,6,6-trichloro-1-hexyl or dodecafluorohexyl;
C₁-C₄-alkoxy: OCH₃, OC₂H₅, n-propoxy, OCH(CH₃)₂, n-butoxy, OCH(CH₃)—C₂H₅, OCH₂—CH(CH₃)₂ or OC(CH₃)₃, preferably OCH₃, OC₂H₅ or OCH(CH₃)₂;
C₁-C₄-haloalkoxy: a C₁-C₄-alkoxy radical as mentioned above which is partially or fully substituted by fluorine, chlorine, bromine and/or iodine, i.e., for example, OCH₂F, OCHF₂, OCF₃, OCH₂Cl, OCH(Cl)₂, OC(Cl)₃, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, OC₂F₅, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, 2,2,3,3,3-pentafluoropropoxy, OCF₂—C₂F₅, 1-(CH₂F)-2-fluoroethoxy, 1-(CH₂Cl)-2-chloroethoxy, 1-(CH₂Br)-2-bromoethoxy, 4-fluorobutoxy, 4-chlorobutoxy, 4-bromobutoxy or nonafluorobutoxy, preferably OCHF₂, OCF₃, dichlorofluoromethoxy, chlorodifluoromethoxy or 2,2,2-trifluoroethoxy;
C₁-C₄-alkylthio: SCH₃, SC₂H₅, n-propylthio, SCH(CH₃)₂, n-butylthio, SCH(CH₃)-C₂H₅, SCH₂—CH(CH₃)₂ or SC(CH₃)₃, preferably SCH₃ or SC₂H₅;
C₁-C₄-haloalkylthio: a C₁-C₄-alkylthio radical as mentioned above which is partially or fully substituted by fluorine, chlorine, bromine and/or iodine, i.e., for example, SCH₂F, SCHF₂, SCH₂Cl, SCH(Cl)₂, SC(Cl)₃, SCF₃, chlorofluoromethylthio, dichlorofluoromethylthio, chlorodifluoromethylthio, 2-fluoroethylthio, 2-chloroethylthio, 2-bromoethylthio, 2-iodoethylthio, 2,2-difluoroethylthio, 2,2,2-trifluoroethylthio, 2-chloro-2-fluoroethylthio, 2-chloro-2,2-difluoroethylthio, 2,2-dichloro-2-fluoroethylthio, 2,2,2-trichloroethylthio, SC₂F₅, 2-fluoropropylthio, 3-fluoropropylthio, 2,2-difluoropropylthio, 2,3-difluoropropylthio, 2-chloropropylthio, 3-chloropropylthio, 2,3-dichloropropylthio, 2-bromopropylthio, 3-bromopropylthio, 3,3,3-trifluoropropylthio, 3,3,3-trichloropropylthio, SCH₂—C₂F₅, SCF₂—C₂F₅, 1-(CH₂F)-2-fluoroethylthio, 1-(CH₂Cl)-2-chloroethylthio, 1-(CH₂Br)-2-bromo-ethylthio, 4-fluorobutylthio, 4-chlorobutylthio, 4-bromobutylthio or SCF₂-CF₂-C₂F₅, preferably SCHF₂, SCF₃, dichlorofluoromethylthio, chlorodifluoromethylthio or 2,2,2-trifluoroethylthio;
C₁-C₄-alkoxy-C₁-C₄-alkyl: C₁-C₄-alkyl which is substituted by C₁-C₄-alkoxy—as mentioned above -, i.e., for example, CH₂-OCH₃, CH₂-OC₂H₅, n-propoxymethyl, CH₂-OCH(CH₃)₂, n-butoxymethyl, (1-methylpropoxy)methyl, (2-methylpropoxy)-methyl, CH₂—OC(CH₃)₃, 2-(methoxy)ethyl, 2-(ethoxy)ethyl, 2-(n-propoxy)ethyl, 2-(1-methylethoxy)ethyl, 2-(n-butoxy)ethyl, 2-(1-methylpropoxy)ethyl, 2-(2-methyl-propoxy)ethyl, 2-(1,1-dimethylethoxy)ethyl, 2-(methoxy)propyl, 2-(ethoxy)propyl, 2-(n-propoxy)propyl, 2-(1-methylethoxy)propyl, 2-(n-butoxy)propyl, 2-(1-methyl-propoxy)propyl, 2-(2-methylpropoxy)propyl, 2-(1,1-dimethylethoxy)propyl, 3-(methoxy)propyl, 3-(ethoxy)propyl, 3-(n-propoxy)propyl, 3-(1-methylethoxy)-propyl, 3-(n-butoxy)propyl, 3-(1-methylpropoxy)propyl, 3-(2-methylpropoxy)-propyl, 3-(1,1-dimethylethoxy)propyl, 2-(methoxy)butyl, 2-(ethoxy)butyl, 2-(n-propoxy)butyl, 2-(1-methylethoxy)butyl, 2-(n-butoxy)butyl, 2-(1-methylpropoxy)-butyl, 2-(2-methylpropoxy)butyl, 2-(1,1-dimethylethoxy)butyl, 3-(methoxy)butyl, 3-(ethoxy)butyl, 3-(n-propoxy)butyl, 3-(1-methylethoxy)butyl, 3-(n-butoxy)butyl, 3-(1-methylpropoxy)butyl, 3-(2-methylpropoxy)butyl, 3-(1,1-dimethylethoxy)butyl, 4-(methoxy)butyl, 4-(ethoxy)butyl, 4-(n-propoxy)butyl, 4-(1-methylethoxy)butyl, 4-(n-butoxy)butyl, 4-(1-methylpropoxy)butyl, 4-(2-methylpropoxy)butyl or 4-(1,1-dimethylethoxy)butyl, preferably CH₂—OCH₃, CH₂—OC₂H₅, 2-methoxyethyl or 2-ethoxyethyl;
(C₁-C₄-alkyl)carbonyl: CO—CH₃, CO—C₂H₅, CO—CH₂—C₂H₅, CO—CH(CH₃)₂, n-butylcarbonyl, CO—CH(CH₃)—C₂H₅, CO—CH₂—CH(CH₃)₂ or CO—C(CH₃)₃, preferably CO—CH₃ or CO—C₂H₅;
(C₁-C₄-alkoxy)carbonyl: CO—OCH₃, CO-OC₂H₅, n-propoxycarbonyl, CO—OCH(CH₃)₂, n-butoxycarbonyl, CO—OCH(CH₃)—C₂H₅, CO—OCH₂—CH(CH₃)₂ or CO—OC(CH₃)₃, preferably CO—OCH₃ or CO—OC₂H₅;
C₁-C₄-alkylsulfinyl: SO—CH₃, SO—C₂H₅, SO—CH₂—C₂H₅, SO—CH(CH₃)₂, n-butylsulfinyl, SO—CH(CH₃)—C₂H₅, SO—CH₂—CH(CH₃)₂ or SO—C(CH₃)₃, preferably SO—CH₃ or SO—C₂H₅;
C₁-C₄-haloalkylsulfinyl: a C₁-C₄-alkylsulfinyl radical—as mentioned above—which is partially or fully substituted by fluorine, chlorine, bromine and/or iodine, i.e., for example, SO—CH₂F, SO—CHF₂, SO—CF₃, SO—CH₂Cl, SO—CH(Cl)₂, SO—C(Cl)₃, chlorofluoromethylsulfinyl, dichlorofluoromethylsulfinyl, chlorodifluoromethyl-sulfinyl, 2-fluoroethylsulfinyl, 2-chloroethylsulfinyl, 2-bromoethylsulfinyl, 2-iodo-ethylsulfinyl, 2,2-difluoroethylsulfinyl, 2,2,2-trifluoroethylsulfinyl, 2-chloro-2-fluoroethylsulfinyl, 2-chloro-2,2-difluoroethylsulfinyl, 2,2-dichloro-2-fluoro-ethylsulfinyl, 2,2,2-trichloroethylsulfinyl, SO—C₂F₅, 2-fluoropropylsulfinyl, 3-fluoro-propylsulfinyl, 2,2-difluoropropylsulfinyl, 2,3-difluoropropylsulfinyl, 2-chloropropyl-sulfinyl, 3-chloropropylsulfinyl, 2,3-dichloropropylsulfinyl, 2-bromopropylsulfinyl, 3-bromopropylsulfinyl, 3,3,3-trifluoropropylsulfinyl, 3,3,3-trichloropropylsulfinyl, SO—CH₂—C₂F₅, SO—CF₂—C₂F₅, 1-(fluoromethyl)-2-fluoroethylsulfinyl, 1-(chloro-methyl)-2-chloroethylsulfinyl, 1-(bromomethyl)-2-bromoethylsulfinyl, 4-fluoro-butylsulfinyl, 4-chlorobutylsulfinyl, 4-bromobutylsulfinyl or nonafluorobutylsulfinyl, preferably SO—CF₃, SO—CH₂Cl or 2,2,2-trifluoroethylsulfinyl;
C₁-C₄-alkylsulfonyl: SO₂—CH₃, SO₂—C₂H₅, SO₂—CH₂-C₂H₅, SO₂—CH(CH₃)₂, n-butylsulfonyl, SO₂—CH(CH₃)—C₂H₅, SO₂-CH₂-CH(CH₃)₂ or SO₂-C(CH₃)₃, preferably SO₂-CH₃ or SO₂-C₂H₅;
C₁-C₄-haloalkylsulfonyl: a C₁-C₄-alkylsulfonyl radical—as mentioned above—which is partially or fully substituted by fluorine, chlorine, bromine and/or iodine, i.e., for example, SO₂—CH₂F, SO₂—CHF₂, SOCF₃, SO—CH₂Cl, SO₂—CH(Cl)₂, SO₂—C(Cl)₃, chlorofluoromethylsulfonyl, dichlorofluoromethylsulfonyl, chlorodifluoromethylsulfonyl, 2-fluoroethylsulfonyl, 2-chloroethylsulfonyl, 2-bromoethylsulfonyl, 2-iodoethylsulfonyl, 2,2-difluoroethylsulfonyl, 2,2,2-trifluoroethylsulfonyl, 2-chloro-2-fluoroethylsulfonyl, 2-chloro-2,2-difluoroethylsulfonyl, 2,2-dichloro-2-fluoroethylsulfonyl, 2,2,2-trichloroethylsulfonyl, SO₂—C₂F₅, 2-fluoropropylsulfonyl, 3-fluoropropylsulfonyl, 2,2-difluoropropylsulfonyl, 2,3-difluoropropylsulfonyl, 2-chloropropylsulfonyl, 3-chloropropylsulfonyl, 2,3-dichloropropylsulfonyl, 2-bromopropylsulfonyl, 3-bromopropylsulfonyl, 3,3,3-trifluoro- propylsulfonyl, 3,3,3-trichloropropylsulfonyl, SO₂—CH₂—C₂F₅, SO₂—-CF₂—C₂F₅, 1-(fluoromethyl)-2-fluoroethylsulfonyl, 1-(chloromethyl)-2-chloroethylsulfonyl, 1-(bromomethyl)-2-bromoethylsulfonyl, 4-fluorobutylsulfonyl, 4-chlorobutylsulfonyl, 4-bromobutylsulfonyl or nonafluorobutylsulfonyl, preferably SO₂—CF₃, SO₂—CH₂Cl or 2,2,2-trifluoroethylsulfonyl;
C₁-C₄-alkylamino: NH(CH₃), NH(C₂H₅), propylamino, NH[CH(CH₃)₂], butylamino, 1-methylpropylamino, 2-methylpropylamino, NH[C(CH₃)₃];
di(C₁-C₄-alkyl)amino: N(CH₃)₂, N(C₂H₅)₂, N,N-dipropylamino, N[CH(CH₃)₂]₂, N,N-dibutylamino, N,N-di(1-methylpropyl)amino, N, N-di(2-methylpropyl)amino, N[C(CH₃)₃]₂, N-ethyl-N-methylamino, N-methyl-N-propylamino, N-methyl-N-(1-methylethyl)amino, N-butyl-N-methylamino, N-methyl-N-(1-methylpropyl)amino, N-methyl-N-(2-methylpropyl)amino, N-(1,1-dimethylethyl)-N-methylamino, N-ethyl-N-propylamino, N-ethyl-N-(1-methylethyl)amino, N-butyl-N-ethylamino, N-ethyl-N-(1-methylpropyl)amino, N-ethyl-N-(2-methylpropyl)amino, N-ethyl-N-(1,1-dimethylethyl)amino, N-(1-methylethyl)-N-propylamino, N-butyl-N-propylamino, N-(1-methylpropyl)-N-propylamino, N-(2-methylpropyl)-N-propylamino, N-(1,1-dimethylethyl)-N-propylamino, N-butyl-N-(1-methylethyl)amino, N-(1-methyl-ethyl)-N-(1-methylpropyl)amino, N-(1-methylethyl)-N-(2-methylpropyl)amino, N-(1,1-dimethylethyl)-N-(1-methylethyl)amino, N-butyl-N-(1-methylpropyl)amino, N-butyl-N-(2-methylpropyl)amino, N-butyl-N-(1,1-dimethylethyl)amino, N-(1-methyl-propyl)N-(2-methylpropyl)amino, N-(1,1-dimethylethyl)-N-(1-methylpropyl)amino or N-(1,1-dimethylethyl)-N-(2-methylpropyl)amino, preferably N(CH₃)₂ or N(C₂H₅);
C₁-C₄-alkylaminocarbonyl: for example methylaminocarbonyl, ethylaminocarbonyl, 1-methylethylaminocarbonyl, propylaminocarbonyl, butylaminocarbonyl, 1-methylpropylaminocarbonyl, 2-methylpropylaminocarbonyl, 1,1-dimethylethylaminocarbonyl;
di(C₁-C₄-alkyl)aminocarbonyl: for example N,N-dimethylaminocarbonyl, N,N-diethylaminocarbonyl, N,N-di(1-methylethyl)aminocarbonyl, N,N-dipropylaminocarbonyl, N,N-dibutylaminocarbonyl, N,N-di(1-methylpropyl)aminocarbonyl, N,N-di(2-methylpropyl)aminocarbonyl, N,N-di(1,1-dimethylethyl)aminocarbonyl, N-ethyl-N-methylaminocarbonyl, N-methyl-N-propylaminocarbonyl, N-methyl-N-(1-methylethyl)aminocarbonyl, N-butyl-N-methylaminocarbonyl, N-methyl-N-(1-methylpropyl)aminocarbonyl, N-methyl-N-(2-methylpropyl)aminocarbonyl, N-(1,1-dimethylethyl)-N-methylaminocarbonyl, N-ethyl-N-propylaminocarbonyl, N-ethyl-N-(1-methylethyl)aminocarbonyl, N-butyl-N-ethylaminocarbonyl, N-ethyl-N-(1-methylpropyl)aminocarbonyl, N-ethyl-N-(2-methylpropyl)aminocarbonyl, N-ethyl-N-(1,1-dimethylethyl)aminocarbonyl, N-(1-methylethyl)-N-propylaminocarbonyl, N-butyl-N-propylaminocarbonyl, N-(1-methylpropyl)-N-propylaminocarbonyl, N-(2-methylpropyl)-N-propylaminocarbonyl, N-(1,1-dimethylethyl)-N-propylamino-carbonyl, N-butyl-N-(1-methylethyl)aminocarbonyl, N-(1-methylethyl)-N-(1-methylpropyl)aminocarbonyl, N-(1-methylethyl)-N-(2-methylpropyl)aminocarbonyl, N-(1,1-dimethylethyl)-N-(1-methylethyl)aminocarbonyl, N-butyl-N-(1-methylpropyl)aminocarbonyl, N-butyl-N-(2-methylpropyl)aminocarbonyl, N-butyl-N-(1,1-dimethylethyl)aminocarbonyl, N-(1-methylpropyl)-N-(2-methylpropyl)-aminocarbonyl, N-(1,1-dimethylethyl)-N-(1-methylpropyl)aminocarbonyl or N-(1,1-dimethylethyl)-N-(2-methylpropyl)aminocarbonyl;
C₃-C₆-alkenyl: prop-1-en-1-yl, allyl, 1-methylethenyl, 1-buten-1-yl, 1-buten-2-yl, 1-buten-3-yl, 2-buten-1-yl, 1-methylprop-1-en-1-yl, 2-methylprop-1-en-1-yl, 1-methylprop-2-en-1-yl, 2-methylprop-2-en-1-yl, n-penten-1-yl, n-penten-2-yl, n-penten-3-yl, n-penten-4-yl, 1-methylbut-1-en-1-yl, 2-methylbut-1-en-1-yl, 3-methylbut-1-en-1-yl, 1-methylbut-2-en-1-yl, 2-methylbut-2-en-1-yl, 3-methylbut-2-en-1-yl, 1-methylbut-3-en-1-yl, 2-methylbut-3-en-1-yl, 3-methylbut-3-en-1-yl, 1,1-dimethylprop-2-en-1-yl, 1,2-dimethylprop-1-en-1-yl, 1,2-dimethylprop-2-en-1-yl, 1-ethylprop-1-en-2-yl, 1-ethylprop-2-en-1-yl, n-hex-1-en-1-yl, n-hex-2-en-1-yl, n-hex-3-en-1-yl, n-hex-4-en-1-yl, n-hex-5-en-1-yl, 1-methylpent-1-en-1-yl, 2-methylpent-1-en-1-yl, 3-methylpent-1-en-1-yl, 4-methylpent-1-en-1-yi, 1-methylpent-2-en-1-yl, 2-methylpent-2-en-1-yl, 3-methylpent-2-en-1-yl, 4-methylpent-2-en-1-yl, 1-methylpent-3-en-1-yl, 2-methylpent-3-en-1-yl, 3-methylpent-3-en-1-yl, 4-methylpent-3-en-1-yl, 1-methylpent-4-en-1-yl, 2-methylpent-4-en-1-yl, 3-methylpent-4-en-1-yl, 4-methylpent-4-en-1-yl, 1,1-dimethylbut-2-en-1-yl, 1,1-dimethylbut-3-en-1-yl, 1,2-dimethylbut-1-en-1-yl, 1,2-dimethylbut-2-en-1-yl, 1,2-dimethylbut-3-en-1-yl, 1,3-dimethylbut-1-en-1-yl, 1,3-dimethylbut-2-en-1-yl, 1,3-dimethylbut-3-en-1-yl, 2,2-dimethylbut-3-en-1-yl, 2,3-dimethylbut-1-en-1-yl, 2,3-dimethylbut-2-en-1-yl, 2,3-dimethylbut-3-en-1-yl, 3,3-dimethylbut-1-en-1-yl, 3,3-dimethylbut-2-en-1-yl, 1-ethylbut-1-en-1-yl, 1-ethylbut-2-en-1-yl, 1-ethylbut-3-en-1-yl, 2-ethylbut-1-en-1-yl, 2-ethylbut-2-en-1-yl, 2-ethylbut-3-en-1-yl, 1,1,2-trimethylprop-2-en-1-yl, 1-ethyl-1-methylprop-2-en-1-yl, 1-ethyl-2-methylprop-1-en-1-yl or 1-ethyl-2-methylprop-2-en-1-yl;
C₃-C₆-alkynyl: prop-1-yn-1-yl, prop-2-yn-1-yl, n-but-1-yn-1-yl, n-but-1-yn-3-yl, n-but-1-yn-4-yl, n-but-2-yn-1-yl, n-pent-1-yn-1-yl, n-pent-1-yn-3-yl, n-pent-1-yn-4-yl, n-pent-1-yn-5-yl, n-pent-2-yn-1-yl, n-pent-2-yn-4-yl, n-pent-2-yn-5-yl, 3-methylbut-1-yn-3-yl, 3-methylbut-1-yn-4-yl, n-hex-1-yn-1-yl, n-hex-1-yn-3-yl, n-hex-1-yn-4-yl, n-hex-1-yn-5-yl, n-hex-1-yn-6-yl, n-hex-2-yn-1-yl, n-hex-2-yn-4-yl, n-hex-2-yn-5-yl, n-hex-2-yn-6-yl, n-hex-3-yn-1-yl, n-hex-3-yn-2-yl, 3-methylpent-1-yn-1-yl, 3-methylpent-1-yn-3-yl, 3-methylpent-1-yn-4-yl, 3-methylpent-1-yn-5-yl, 4-methylpent-1-yn-1-yl, 4-methylpent-2-yn-4-yl or 4-methylpent-2-yn-5-yl, preferably prop-2-yn-1-yl;
C₃-C₇-cycloalkyl: cyclopropyl, cyclobutyl, cyclopentyl, cyclohexyl or cycloheptyl;
C₃-C₇-cycloalkyl which contains a carbonyl or thiocarbonyl ring member: for example cyclobutanon-2-yl, cyclobutanon-3-yl, cyclopentanon-2-yl, cyclopentanon-3-yl, cyclohexanon-2-yl, cyclohexanon-4-yl, cycloheptanon-2-yl, cyclooctanon-2-yl, cyclobutanethion-2-yl, cyclobutanethion-3-yl, cyclopentanethion-2-yl, cyclopentanethion-3-yl, cyclohexanethion-2-yl, cyclohexanethion-4-yl, cycloheptanethion-2-yl or cyclooctanethion-2-yl, preferably cyclopentanon-2-yl or cyclohexanon-2-yl.

Among the phenyluracils of formula I applied according to the invention, preference is given to those wherein the radicals R¹ to R⁷ independently of one another, but preferably combined, have the meanings given below:

R¹ is methyl or NH₂;

R² is trifluoromethyl;

R³ is hydrogen, fluorine or chlorine, in particular hydrogen or fluorine, especially preferred fluorine;

R⁴ is halogen or cyano, in particular chlorine or cyano, especially preferred chlorine;

R⁵ is hydrogen;

R⁶, R⁷ independently of one another are hydrogen, C₁-C₆-alkyl, C₃-C₆-alkenyl, C₃-C₆-alkynyl, C₃-C₇-cycloalkyl, C₃-C₇-cycloalkenyl, phenyl or benzyl, or form together with the nitrogen atom form a pyrrolidine, piperidine, morpholine, N-methylpiperazine or perhydroazepine ring; in particular identical or different C₁-C₆-alkyl radicals.

Particular preference is given to the application of phenyluracils of formula I.1 (=phenyluracils of formula I in which R²=CF₃, R³=F, R⁴=Cl and R⁵=H).

Extraordinary preference is given to the application of compounds of formula I.1.1 to I.1.74 of table 1, where the definitions of the radicals R¹, R⁶ and R⁷ are of particular importance for the compounds applied according to the invention not only in combination with another but in each case also on their own.

TABLE 1

| | |
|---|---|
| | I.1 |
| 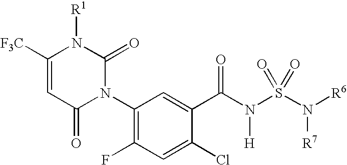 | |

| Phenyluracil I | R¹ | R⁶ | R⁷ |
|---|---|---|---|
| I.1.1 | methyl | methyl | methyl |
| I.1.2 | methyl | methyl | ethyl |
| I.1.3 | methyl | methyl | n-propyl |
| I.1.4 | methyl | methyl | isopropyl |
| I.1.5 | methyl | methyl | n-butyl |
| I.1.6 | methyl | methyl | s-butyl |
| I.1.7 | methyl | methyl | isobutyl |
| I.1.8 | methyl | methyl | t-butyl |
| I.1.9 | methyl | methyl | n-pentyl |
| I.1.10 | methyl | methyl | n-hexyl |
| I.1.11 | methyl | methyl | allyl |
| I.1.12 | methyl | methyl | propargyl |
| I.1.13 | methyl | methyl | phenyl |
| I.1.14 | methyl | methyl | benzyl |
| I.1.15 | methyl | ethyl | ethyl |
| I.1.16 | methyl | ethyl | n-propyl |
| I.1.17 | methyl | ethyl | isopropyl |
| I.1.18 | methyl | ethyl | n-butyl |
| I.1.19 | methyl | ethyl | n-pentyl |
| I.1.20 | methyl | ethyl | n-hexyl |
| I.1.21 | methyl | n-propyl | n-propyl |
| I.1.22 | methyl | n-propyl | isopropyl |
| I.1.23 | methyl | n-propyl | n-butyl |
| I.1.24 | methyl | n-propyl | n-pentyl |
| I.1.25 | methyl | n-propyl | n-hexyl |
| I.1.26 | methyl | isopropyl | isopropyl |
| I.1.27 | methyl | isopropyl | n-butyl |
| I.1.28 | methyl | isopropyl | n-pentyl |
| I.1.29 | methyl | isopropyl | n-hexyl |
| I.1.30 | methyl | n-butyl | n-butyl |
| I.1.31 | methyl | n-butyl | n-pentyl |
| I.1.32 | methyl | n-butyl | n-hexyl |
| I.1.33 | methyl | n-pentyl | n-pentyl |
| I.1.34 | methyl | n-pentyl | n-hexyl |
| I.1.35 | methyl | n-hexyl | n-hexyl |

| | | |
|---|---|---|
| I.1.36 | methyl | —(CH₂)₄— |
| I.1.37 | methyl | —(CH₂)₂—O—(CH₂)₂— |

| | | | |
|---|---|---|---|
| I.1.38 | amino | methyl | methyl |
| I.1.39 | amino | methyl | ethyl |
| I.1.40 | amino | methyl | n-propyl |
| I.1.41 | amino | methyl | isopropyl |
| I.1.42 | amino | methyl | n-butyl |
| I.1.43 | amino | methyl | s-butyl |
| I.1.44 | amino | methyl | isobutyl |
| I.1.45 | amino | methyl | t-butyl |
| I.1.46 | amino | methyl | n-pentyl |
| I.1.47 | amino | methyl | n-hexyl |
| I.1.48 | amino | methyl | allyl |
| I.1.49 | amino | methyl | propargyl |
| I.1.50 | amino | methyl | phenyl |
| I.1.51 | amino | methyl | benzyl |
| I.1.52 | amino | ethyl | ethyl |
| I.1.53 | amino | ethyl | n-propyl |
| I.1.54 | amino | ethyl | isopropyl |
| I.1.55 | amino | ethyl | n-butyl |
| I.1.56 | amino | ethyl | n-pentyl |
| I.1.57 | amino | ethyl | n-hexyl |
| I.1.58 | amino | n-propyl | propyl |
| I.1.59 | amino | n-propyl | isopropyl |
| I.1.60 | amino | n-propyl | n-butyl |
| I.1.61 | amino | n-propyl | n-pentyl |
| I.1.62 | amino | n-propyl | n-hexyl |
| I.1.63 | amino | isopropyl | isopropyl |
| I.1.64 | amino | isopropyl | n-butyl |
| I.1.65 | amino | isopropyl | n-pentyl |
| I.1.66 | amino | isopropyl | n-hexyl |
| I.1.67 | amino | n-butyl | n-butyl |
| I.1.68 | amino | n-butyl | n-pentyl |
| I.1.69 | amino | n-butyl | n-hexyl |
| I.1.70 | amino | n-pentyl | n-pentyl |
| I.1.71 | amino | n-pentyl | n-hexyl |
| I.1.72 | amino | n-hexyl | n-hexyl |

| | | |
|---|---|---|
| I.1.73 | amino | —(CH₂)₄— |
| I.1.74 | amino | —(CH₂)₂—O—(CH₂)₂— |

In one particular preferred embodiment of the invention preferred is the application of at least one phenyluracil of formula I; especially preferred the application of at least one phenyluracil of formula I.a; extraordinary preferred the application of at least one phenyluracil of formula I.1.1 to I.1.74.

In another preferred embodiment of the invention,
preferred is the application of at least one phenyluracil of formula I and at least one herbicide selected from groups B1 to B6;
especially preferred the application of at least one phenyluracil of formula I.a and at least one herbicide selected from groups B1 to B6;
extraordinary preferred the application of at least one phenyluracil of formula I.1.1 to I.1.74 and at least one herbicide selected from groups B1 to B6.

Among the compositions applied according to the invention, particular preference is given to those which comprise at least one phenyluracil of formula I, preferably at least one phenyluracil of formula I.1; and at least one herbicide B selected from groups B1, B3, B4, B5 and B6, in particular at least one herbicide B selected from groups B1, B3 and B4.

Examples for herbicides B optionally applied according to the present invention in combination with the 3-phenyluracils of the formula I are:

B1 from the group of the ALS inhibitors: amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac;

B2 from the group of the photosynthesis inhibitors: atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthylazine, terbutryne, trietazine, ametridione, amibuzin, hexazinone, isomethiozin, metamitron, metribuzin, bromacil, isocil, lenacil, terbacil, brompyrazon, chloridazon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluron, anisuron, buturon, chlorbromuron, chloreturon, chlorotoluron, chloroxuron, difenoxuron, dimefuron, diuron, fenuron, fluometuron, fluothiuron, isoproturon, linuron, methiuron, metobenzuron, metobromuron, metoxuron, monolinuron, monuron, neburon, parafluron, phenobenzuron, siduron, tetrafluron, thidiazuron, cyperquat, diethamquat, difenzoquat, diquat, morfamquat, paraquat, bromobonil, bromoxynil, chloroxynil, iodobonil, ioxynil, amicarbazone, bromofenoxim, flumezin, methazole, bentazon, propanil, pentanochlor, pyridate, and pyridafol;

B3 from the group of the EPSP synthase inhibitors: glyphosate;

B4 from the group of the glutamine synthase inhibitors: glufosinate and bilanaphos;

B5 from the group of the auxin herbicides: clomeprop, 2,4-D, 2,4,5-T, MCPA, MCPA thioethyl, dichlorprop, dichlorprop-P, mecoprop, mecoprop-P, 2,4-DB, MCPB, chloramben, dicamba, 2,3,6-TBA, tricamba, quinclorac, quinmerac, aminopyralid, clopyralid, fluroxypyr, picloram, triclopyr and benazolin;

B6 fosamine.

Preferred herbicides B of groups B1 to B6 applied according to the invention are the compounds listed below:

B1 amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac;

B2 atrazine, ametryne, cyanazine, simazine, hexazinone, metribuzin, tebuthiuron, diuron, bromoxynil and paraquat;

B3 glyphosate;

B4 glufosinate;

B5 2,4-D, 2,4-DB, dichlorprop, dichlorprop-P, MCPA, MCPB, mecoprop, mecoprop-P, dicamba, quinclorac, quinmerac, aminopyralid, clopyralid, fluroxypyr, picloram, triclopyr, benazolin;

B6 fosamine;

and their agriculturally acceptable salts and, in the case of compounds having a carboxyl group, also their agriculturally acceptable derivatives.

Among the compositions applied according to the invention, particular preference is given to the application of those compositions which comprise a phenyluracil of formula I, especially of formula I.1, in combinations with at least one, preferably exactly one herbicidally active compound selected from the group consisting of groups B1, B3, B5 and B6; more preferred selected from the group consisting of groups B1 and B3.

With regard to the preferred herbicides B of groups B1, B3, B5 and B6 reference is made to the preferred compounds listed above and below.

In another particularly preferred embodiment of the invention, preference is given to the application of those compositions which comprise a phenyluracil of formula I, especially of formula I.1, in combination with at least one, preferably especially exactly one herbicidally active compound of the group B1, in particular selected from the group consisting of metsulfuron, sulfometuron, imazamethabenz, imazamox, imazapic, imazapyr, imazaquin and imazethapyr.

In another particularly preferred embodiment of the invention, preference is given to the application of those compositions which comprise a phenyluracil of formula I, especially of formula I.1, in combination with at least one, preferably especially exactly one herbicidally active compound of the group B2, in particular selected from the group consisting of atrazine, cyanazine, hexazione, diuron, bromoxynil and paraquat.

In another particularly preferred embodiment of the invention, preference is given to the application of those compositions which comprise a phenyluracil of formula I, especially of formula I.1, in combination with at least one, preferably especially exactly one herbicidally active compound of the group B3, in particular glyphosate.

In another particularly preferred embodiment of the invention, preference is given to the application of those compositions which comprise a phenyluracil of formula I, especially of formula I.1, in combination with at least one, preferably especially exactly one herbicidally active compound of the group B4, in particular glufosinate.

In another particularly preferred embodiment of the invention, preference is given to the application of those compositions which comprise a phenyluracil of formula I, especially of formula I.1, in combination with at least one, preferably especially exactly one herbicidally active compound of the group B5, in particular selected from the group consisting of 2,4-D, dicamba, aminopyralid, clopyralid, fluroxypyr, picloram and triclopyr.

In another particularly preferred embodiment of the invention, preference is given to the application of those compositions which comprise a phenyluracil of formula I, especially of formula I.1, in combination with at least one, preferably especially exactly one herbicidally active compound of the group B6, in particular fosamine.

Among the compositions applied according to the invention, particular preference is especially given to the application of those compositions which comprise a phenyluracil of formula I, especially of formula I.1, in combination with at least one, preferably especially exactly one herbicidally active compound selected from the group consisting of metsulfuron, sulfometuron, imazapyr, hexazione, paraquat, glyphosate, glufosinate, 2,4-D, dicamba, aminopyralid, clopyralid, picloram, triclopyr and fosamine; preferably selected from the group consisting of sulfometuron, imazapyr, glyphosate, triclopyr and fosamine.

Particular preference is given, for example, to the application of those compositions which comprise a phenyluracil of formula I.1 and a herbicide B listed in one row of table 2 (compositions 1.1 to 1.14). The weight ratios of the individual components in the compositions 1.1 to 1.14 are within the stated limits.

TABLE 2

| Composition No. | Herbicide B |
|---|---|
| 1.1 | metsulfuron |
| 1.2 | sulfometuron |
| 1.3 | imazapyr |
| 1.4 | hexazione |
| 1.5 | paraquat |
| 1.6 | glyphosate |
| 1.7 | glufosinate |
| 1.8 | 2,4-D |
| 1.9 | dicamba |
| 1.10 | aminopyralid |
| 1.11 | clopyralid |
| 1.12 | picloram |
| 1.13 | triclopyr |
| 1.14 | fosamine |

Preference is also given to the application of compositions 2.1-2.14 which differ from the corresponding compositions 1.1-1.14 only in that the phenyluracil I.1.1 is replaced by the phenyluracil I.1.2.

Preference is also given to the application of compositions 3.1-3.14 which differ from the corresponding compositions 1.1 -1.14 only in that the phenyluracil I.1.1 is replaced by the phenyluracil I.1.3.

Preference is also given to the application of compositions 4.1-4.14 which differ from the corresponding compositions 1.1-1.14 only in that the phenyluracil I.1.1 is replaced by the phenyluracil I.1.4.

Preference is also given to the application of compositions 5.1-5.14 which differ from the corresponding compositions 1.1-1.14 only in that the phenyluracil I.1.1 is replaced by the phenyluracil I.1.5.

Preference is also given to the application of compositions 6.1-6.14 which differ from the corresponding compositions 1.1-1.14 only in that the phenyluracil I.1.1 is replaced by the phenyluracil I.1.6.

Preference is also given to the application of compositions 7.1-7.14 which differ from the corresponding compositions 1.1-1.14 only in that the phenyluracil I.1.1 is replaced by the phenyluracil I.1.7.

Preference is also given to the application of compositions 8.1-8.14 which differ from the corresponding compositions 1.1-1.14 only in that the phenyluracil I.1.1 is replaced by the phenyluracil I.1.8.

Preference is also given to the application of compositions 9.1-9.14 which differ from the corresponding compositions 1.1-1.14 only in that the phenyluracil I.1.1 is replaced by the phenyluracil I.1.9.

Preference is also given to the application of compositions 10.1-10.14 which differ from the corresponding compositions 1.1-1.14 only in that the phenyluracil I.1.1 is replaced by the phenyluracil I.1.10.

Preference is also given to the application of compositions 11.1-11.14 which differ from the corresponding compositions 1.1-1.14 only in that the phenyluracil I.1.1 is replaced by the phenyluracil I.1.11.

Preference is also given to the application of compositions 12.1-12.14 which differ from the corresponding compositions 1.1-1.14 only in that the phenyluracil I.1.1 is replaced by the phenyluracil I.1.12.

Preference is also given to the application of compositions 13.1-13.14 which differ from the corresponding compositions 1.1-1.14 only in that the phenyluracil I.1.1 is replaced by the phenyluracil I.1.13.

Preference is also given to the application of compositions 14.1-14.14 which differ from the corresponding compositions 1.1-1.14 only in that the phenyluracil I.1.1 is replaced by the phenyluracil I.1.14.

Preference is also given to the application of compositions 15.1-15.14 which differ from the corresponding compositions 1.1 - 1.14 only in that the phenyluracil I.1.1 is replaced by the phenyluracil I.1.15.

Preference is also given to the application of compositions 16.1-16.14 which differ from the corresponding compositions 1.1-1.14 only in that the phenyluracil I.1.1 is replaced by the phenyluracil I.1.16.

Preference is also given to the application of compositions 17.1-17.14 which differ from the corresponding compositions 1.1-1.14 only in that the phenyluracil I.1.1 is replaced by the phenyluracil I.1.17.

Preference is also given to the application of compositions 18.1-18.14 which differ from the corresponding compositions 1.1-1.14 only in that the phenyluracil I.1.1 is replaced by the phenyluracil I.1.18.

Preference is also given to the application of compositions 19.1-19.14 which differ from the corresponding compositions 1.1-1.14 only in that the phenyluracil I.1.1 is replaced by the phenyluracil I.1.19.

Preference is also given to the application of compositions 20.1-20.14 which differ from the corresponding compositions 1.1-1.14 only in that the phenyluracil I.1.1 is replaced by the phenyluracil I.1.20.

Preference is also given to the application of compositions 21.1-21.14 which differ from the corresponding compositions 1.1-1.14 only in that the phenyluracil I.1.1 is replaced by the phenyluracil I.1.21.

Preference is also given to the application of compositions 22.1-22.14 which differ from the corresponding compositions 1.1-1.14 only in that the phenyluracil I.1.1 is replaced by the phenyluracil I.1.22.

Preference is also given to the application of compositions 23.1-23.14 which differ from the corresponding compositions 1.1-1.14 only in that the phenyluracil I.1.1 is replaced by the phenyluracil I.1.23.

Preference is also given to the application of compositions 24.1-24.14 which differ from the corresponding compositions 1.1-1.14 only in that the phenyluracil I.1.1 is replaced by the phenyluracil I.1.24.

Preference is also given to the application of compositions 25.1-25.14 which differ from the corresponding compositions 1.1-1.14 only in that the phenyluracil I.1.1 is replaced by the phenyluracil I.1.25.

Preference is also given to the application of compositions 26.1-26.14 which differ from the corresponding compositions 1.1-1.14 only in that the phenyluracil I.1.1 is replaced by the phenyluracil I.1.26.

Preference is also given to the application of compositions 27.1-27.14 which differ from the corresponding compositions 1.1-1.14 only in that the phenyluracil I.1.1 is replaced by the phenyluracil I.1.27.

Preference is also given to the application of compositions 28.1-28.14 which differ from the corresponding compositions 1.1-1.14 only in that the phenyluracil I.1.1 is replaced by the phenyluracil I.1.28.

Preference is also given to the application of compositions 29.1-29.14 which differ from the corresponding compositions 1.1-1.14 only in that the phenyluracil I.1.1 is replaced by the phenyluracil I.1.29.

Preference is also given to the application of compositions 30.1-30.14 which differ from the corresponding compositions 1.1-1.14 only in that the phenyluracil I.1.1 is replaced by the phenyluracil I.1.30.

Preference is also given to the application of compositions 31.1-31.14 which differ from the corresponding compositions 1.1-1.14 only in that the phenyluracil I.1.1 is replaced by the phenyluracil I.1.31.

Preference is also given to the application of compositions 32.1-32.14 which differ from the corresponding compositions 1.1-1.14 only in that the phenyluracil I.1.1 is replaced by the phenyluracil I.1.32.

Preference is also given to the application of compositions 33.1-33.14 which differ from the corresponding compositions 1.1-1.14 only in that the phenyluracil I.1.1 is replaced by the phenyluracil I.1.33.

Preference is also given to the application of compositions 34.1-34.14 which differ from the corresponding compositions 1.1-1.14 only in that the phenyluracil I.1.1 is replaced by the phenyluracil I.1.34.

Preference is also given to the application of compositions 35.1-35.14 which differ from the corresponding compositions 1.1-1.14 only in that the phenyluracil I.1.1 is replaced by the phenyluracil I.1.35.

Preference is also given to the application of compositions 36.1-36.14 which differ from the corresponding compositions 1.1-1.14 only in that the phenyluracil I.1.1 is replaced by the phenyluracil I.1.36.

Preference is also given to the application of compositions 37.1-37.14 which differ from the corresponding compositions 1.1-1.14 only in that the phenyluracil I.1.1 is replaced by the phenyluracil I.1.37.

Preference is also given to the application of compositions 38.1-38.14 which differ from the corresponding compositions 1.1-1.14 only in that the phenyluracil I.1.1 is replaced by the phenyluracil I.1.38.

Preference is also given to the application of compositions 39.1-39.14 which differ from the corresponding compositions 1.1-1.14 only in that the phenyluracil I.1.1 is replaced by the phenyluracil I.1.39.

Preference is also given to the application of compositions 40.1-40.14 which differ from the corresponding compositions 1.1-1.14 only in that the phenyluracil I.1.1 is replaced by the phenyluracil I.1.40.

Preference is also given to the application of compositions 41.1-41.14 which differ from the corresponding compositions 1.1-1.14 only in that the phenyluracil I.1.1 is replaced by the phenyluracil I.1.41.

Preference is also given to the application of compositions 42.1-42.14 which differ from the corresponding compositions 1.1-1.14 only in that the phenyluracil I.1.1 is replaced by the phenyluracil I.1.42.

Preference is also given to the application of compositions 43.1-43.14 which differ from the corresponding compositions 1.1-1.14 only in that the phenyluracil I.1.1 is replaced by the phenyluracil I.1.43.

Preference is also given to the application of compositions 44.1-44.14 which differ from the corresponding compositions 1.1-1.14 only in that the phenyluracil I.1.1 is replaced by the phenyluracil I.1.44.

Preference is also given to the application of compositions 45.1-45.14 which differ from the corresponding compositions 1.1-1.14 only in that the phenyluracil I.1.1 is replaced by the phenyluracil I.1.45.

Preference is also given to the application of compositions 46.1-46.14 which differ from the corresponding compositions 1.1-1.14 only in that the phenyluracil I.1.1 is replaced by the phenyluracil I.1.46.

Preference is also given to the application of compositions 47.1-47.14 which differ from the corresponding compositions 1.1-1.14 only in that the phenyluracil I.1.1 is replaced by the phenyluracil I.1.47.

Preference is also given to the application of compositions 48.1-48.14 which differ from the corresponding compositions 1.1-1.14 only in that the phenyluracil I.1.1 is replaced by the phenyluracil I.1.48.

Preference is also given to the application of compositions 49.1-49.14 which differ from the corresponding compositions 1.1-1.14 only in that the phenyluracil I.1.1 is replaced by the phenyluracil I.1.49.

Preference is also given to the application of compositions 50.1-50.14 which differ from the corresponding compositions 1.1-1.14 only in that the phenyluracil I.1.1 is replaced by the phenyluracil I.1.50.

Preference is also given to the application of compositions 51.1-51.14 which differ from the corresponding compositions 1.1-1.14 only in that the phenyluracil I.1.1 is replaced by the phenyluracil I.1.51.

Preference is also given to the application of compositions 52.1-52.14 which differ from the corresponding compositions 1.1-1.14 only in that the phenyluracil I.1.1 is replaced by the phenyluracil I.1.52.

Preference is also given to the application of compositions 53.1-53.14 which differ from the corresponding compositions 1.1-1.14 only in that the phenyluracil I.1.1 is replaced by the phenyluracil I.1.53.

Preference is also given to the application of compositions 54.1-54.14 which differ from the corresponding compositions 1.1-1.14 only in that the phenyluracil I.1.1 is replaced by the phenyluracil I.1.54.

Preference is also given to the application of compositions 55.1-55.14 which differ from the corresponding compositions 1.1-1.14 only in that the phenyluracil I.1.1 is replaced by the phenyluracil I.1.55.

Preference is also given to the application of compositions 56.1-56.14 which differ from the corresponding compositions 1.1-1.14 only in that the phenyluracil I.1.1 is replaced by the phenyluracil I.1.56.

Preference is also given to the application of compositions 57.1-57.14 which differ from the corresponding compositions 1.1-1.14 only in that the phenyluracil I.1.1 is replaced by the phenyluracil I.1.57.

Preference is also given to the application of compositions 58.1-58.14 which differ from the corresponding compositions 1.1-1.14 only in that the phenyluracil I.1.1 is replaced by the phenyluracil I.1.58.

Preference is also given to the application of compositions 59.1-59.14 which differ from the corresponding compositions 1.1-1.14 only in that the phenyluracil I.1.1 is replaced by the phenyluracil I.1.59.

Preference is also given to the application of compositions 60.1-60.14 which differ from the corresponding compositions 1.1-1.14 only in that the phenyluracil I.1.1 is replaced by the phenyluracil I.1.60.

Preference is also given to the application of compositions 61.1-61.14 which differ from the corresponding compositions 1.1-1.14 only in that the phenyluracil I.1.1 is replaced by the phenyluracil I.1.61.

Preference is also given to the application of compositions 62.1-62.14 which differ from the corresponding compositions 1.1-1.14 only in that the phenyluracil I.1.1 is replaced by the phenyluracil I.1.62.

Preference is also given to the application of compositions 63.1-63.14 which differ from the corresponding compositions 1.1-1.14 only in that the phenyluracil I.1.1 is replaced by the phenyluracil I.1.63.

Preference is also given to the application of compositions 64.1-64.14 which differ from the corresponding compositions 1.1-1.14 only in that the phenyluracil I.1.1 is replaced by the phenyluracil I.1.64.

Preference is also given to the application of compositions 65.1-65.14 which differ from the corresponding compositions 1.1-1.14 only in that the phenyluracil I.1.1 is replaced by the phenyluracil I.1.65.

Preference is also given to the application of compositions 66.1-66.14 which differ from the corresponding compositions 1.1-1.14 only in that the phenyluracil I.1.1 is replaced by the phenyluracil I.1.66.

Preference is also given to the application of compositions 67.1-67.14 which differ from the corresponding compositions 1.1-1.14 only in that the phenyluracil I.1.1 is replaced by the phenyluracil I.1.67.

Preference is also given to the application of compositions 68.1-68.14 which differ from the corresponding compositions 1.1-1.14 only in that the phenyluracil I.1.1 is replaced by the phenyluracil I.1.68.

Preference is also given to the application of compositions 69.1-69.14 which differ from the corresponding compositions 1.1-1.14 only in that the phenyluracil I.1.1 is replaced by the phenyluracil I.1.69.

Preference is also given to the application of compositions 70.1-70.14 which differ from the corresponding compositions 1.1-1.14 only in that the phenyluracil I.1.1 is replaced by the phenyluracil I.1.70.

Preference is also given to the application of compositions 71.1-71.14 which differ from the corresponding compositions 1.1-1.14 only in that the phenyluracil I.1.1 is replaced by the phenyluracil I.1.71.

Preference is also given to the application of compositions 72.1-72.14 which differ from the corresponding compositions 1.1-1.14 only in that the phenyluracil I.1.1 is replaced by the phenyluracil I.1.72.

Preference is also given to the application of compositions 73.1-73.14 which differ from the corresponding compositions 1.1-1.14 only in that the phenyluracil I.1.1 is replaced by the phenyluracil I.1.73.

Preference is also given to the application of compositions 74.1-74.14 which differ from the corresponding compositions 1.1-1.14 only in that the phenyluracil I.1.1 is replaced by the phenyluracil I.1.74.

Here and in the following the amounts given for the phenyluracil of formula I and for the optional herbicide B refer to the active portion of the herbicide molecule. Thus in the case of salts or derivatives the amounts refer to the free acid.

In the method according to the invention, which comprises applying at least one phenyluracil of the formula I and optionally at least one herbicide B to coniferous plants, the phenyluracil of the formula I and optionally the herbicide B will be applied in a weight ratio I:B ranging usually from 200:1 to 1:200, preferably from 100:1 to 1:100, more preferred 50:1 to 1:50, in particular preferred from 10:1 to 1:20 and especially preferred from 1:1 to 1:20.

In the method of the present invention the phenyluracil of formula I is usually applied in amounts from 0.010 kg a.i./ha to 1.50 kg a.i./ha, preferably from 0.050 kg a.i./ha to 1.20 kg a.i./ha and especially preferred from 0.10 kg a.i./ha to 1.00 kg a.i. /ha (a.i.=active ingredient).

In the method of the present invention the optionally herbicide B is usually applied in amounts from 0.010 kg a.i./ha to 10.00 kg a.i./ha, preferably from 0.050 kg a.i./ha to 5.00 kg a.i./ha, in particular preferred from 0.20 kg a.i./ha to 3.00 kg a.i./ha, especially preferred from 0.50 kg a.i./ha to 3.00 kg a.i./ha, and extraordinary preferred from 0.50 kg a.i./ha to 1.00 kg a.i./ha.

The phenyluracil of formula I and optionally the herbicide B may be applied by any means which are customary in the field of crop-protection and especially in the field of forestry. The phenyluracil of formula I and optionally the herbicide B may be applied, for example, in the form of directly sprayable aqueous emulsions, suspensions as directly sprayable powders and dusts, and also as highly-concentrated aqueous, oily or other suspensions or dispersions, as oil dispersions or as granules. Depending on the kind of formulation they will be applied by means of spraying, atomizing, dusting, broadcasting or watering. The person skilled in the art is sufficiently familiar with useful formulations and means of applying them. In any case, those formulation and the means of applying them should ensure the finest possible distribution of the active compounds phenyluracil of formula I and optionally of the herbicide B.

The phenyluracil of formula I and optionally the herbicide B are applied to the area to be protected from wildling conifer mainly by spraying. Application can be carried out by customary spraying techniques using, for example, water as carrier and spray liquor rates ranging from about 50 to 1000 L/ha (for example from 50 to 500 I/ha). Application of the phenyluracil of formula I and optionally of the herbicide B by the low-volume and the ultra-low-volume method is possible, as is their application in the form of microgranules.

Application of the phenyluracil of formula I and optionally of the herbicide B can be done by over-the-top treatment of the wildlings or by directed treatment of the wildlings, e. g. by directed or spot-spraying.

In order to achieve wildling conifer control, the phenyluracil of formula I and optionally the herbicide B are preferably applied to the naturally seeded coniferous seedlings as a whole or to their roots or leaves. However the phenyluracil of formula I and optionally the herbicide B can be also applied to the germinants of the conifers to be controlled. In a preferred embodiment of the invention, control is achieved by applying the phenyluracil of formula I and optionally the herbicide B after germination of the wildling seed, i.e. by post-emergence treatment of the wild conifer seedlings.

In the method of the invention the phenyluracil of formula I and the herbicide B can be applied jointly or separately, i.e. simultaneously or successively. In order to achieve effective control of the naturally seeded coniferous plants, it is only required that the phenyluracil of formula I and the herbicide B, if present, affect the coniferous plants to be controlled or their parts at the same time. The term “coniferous plants to be controlled or their parts” is understood to comprise naturally seeded conifer seedlings, their roots, cones and leaves as well as their seeds and their germinants. Consequently, the herbicidal composition of the invention can be formulated in one formulation that comprises both, the phenyluracil of formula I and the herbicide B, if present, as well as in two separate formulations as a two-part kit, i.e. one formulation comprises the phenyluracil of formula I and the other comprises the herbicide B. These two separate formulations can be mixed before applying them and thus the phenyluracil of formula I and the herbicide B are applied jointly. However these two formulations may also be applied separately, provided that the phenyluracil of formula I and the herbicide B act at the same time on the plants to be controlled or on their parts. It is, however, preferred to apply the phenyluracil of formula I and the herbicide B, if present, jointly.

The method according to the present invention is suitable for controlling naturally seeded coniferous plants, in particular wildling plants belonging to the family of Pinaceae, Cupressaceae, Taxodiaceae, Aucariaceae and Taxaceae.

It is especially useful for controlling wildling conifer plants belonging to the family of Pinaceae belonging to the genus of

Pinus (e.g. P. aristata, P. armandii, P. attunuata, P. australes, P. ayacahuite, P. balfouricana, P. banksiana, P. brutia, P. bungeana, P. canariensis, P. cembra L., P. clausa, P. contortae (e.g. P. contorta, P. contorta var. contorta, P. contorta var. latifolia), P. coulteri, P. densiflora, P. flexilis, P. echinata, P. elliotii, P. glabra, P. halepensis, P. jeffreyi, P. koraiensis, P. lambertiana, P. leucodermis Ant., P. montezumae, P. monticola, P. mugo Turra s.st., P. muricata, P. nigrae (e.g. P. nigra J. F. Arnold, P. nigra var. austriaca, P. nigra var. caramanica, P. nigra var. maritima), P. palustris, P. parviflora, P. patula, P. petaphylla, P. peuce, P. pinaster, P. pinea, P. ponderosa, P. pumila, P. pungens, P.radiata, P. resinosa, P. rigida, P. rotundata, P. serotina, P. strobus, P. sylvestres, P. taeda, P. thunbergii, P. unicata, P. virginiana, P. wallichiana, P. x holfodiana, P. x rotundata Link);

Picea (e.g. P. bicolor, P. abies (L.) H. Kast, P. aperata, P. brachytyla, P. breweriana, P. engelmannii, P. glauca, P. jezoensis var. hondoensis, P. likiangensis, P. mariana, P. morrisonicola, P. obovata, P. omorika, P. orientalis, P. polita, P. pungens, P. rubens, P. schrenkiana, P. sitchensis, P. smithiana, P. spinulosa, P. wilsonii Mast.);

Abies (e.g. A. alba Mill., A. amabilis, A. balsamea, A. borisii-regis, A. bornmuelleriana, A. bracteata, A. cephalonica Loudon, A. cilicica, A. concolor, A. concolor var. lowiana, A. delavayi, A. fargesii, A. firma, A. forrestii, A. grandis, A. holophylla, A. homolepsis, A. koreana Wilson, A. lasiocarpa, (Hook.) Nutt., A. magnifiva, A. mariesli, A. nephrolepsis, A. nordmanniana (Stev.) Spach, A. numidica, A. pindrow, A. pinsapo Boissier, A. procera Rehder, A. recurvata, A. sachalinensis, A. sibirica, A. spectabilis, A. veitchil Lindl.);

Tsuga (e.g. T. Canadensis, T. caroliniana Engelm., T. chinensis, T. diversifolia (Maxim.)Mast., T. dumosa, T. heterophylla, T. mertensiana, T. sieboldii Carr., T. x jeffreyi);

Pseudotsuga (e.g. P. japonica, P. macrocarpa, P. menziesii (Mirbel) Franco);

Larix (e.g. L. x eurolepis, L. deciduas Mill., L. gmelinii, L. griffithii, L. kaempferi, L. laricina, L. occidentalis, L. sibirica);

Pseudolarix (e.g. P. amabilis, P. kaempferi); and

Cedrus (e.g. C. brevifoila, C. deodara (Roxb.) G. Don, C. libani, C. libani ssp. Atlantica).

Furthermore it is especially useful for controlling wildling conifer plants belonging to the family of Cupressaceae belonging to the genus of

Cupressus (e.g. C. arizonica, C. glabra, C. goveniana, C. lusitanica, C. macrocarpa, C. sempervirens, C. torulosa, Austrocedrus chilensis, Calocedrus decurrens, Fitzroya cupressoides);

Chamaecyparis (e.g. C. formosensis, C. Iawsoniana Murray, C. nootkatensis, C. obtuse, C. pisifera, C. thyoides);

Thuja (e.g. T. articulata, T. koraiensis, T. occidentalis L., T. orientalis, T. plicata Don., T. standishii, T. dolabrata (L.) Sieb & Zucc., Microbiota decussata Komarov); and

Juniperus (e.g. J. chinensis, J. communis L. s.l., J. commuins ssp. alpina Celak, J, communis ssp. communis, J. conferta, J. drupacea Lab., J. horizontalis Moench, J. oxycedrus L., J. phoenicea L., J. procumbens, J. recurva Buchanan-Hamilton ex D. Don., J. rigida, J. Sabina L., J. scopulorum, J. sibirica, J. squamata, J. thurifera, J. virgiania).

Furthermore it is especially useful for controlling wildling conifer plants belonging to the family of Taxodiaceae belonging to the genus of

Taxodium (e.g. Athrotaxis selaginoides, Cryptomeria japonica (L.)D. Don., Cryptomeria japonica ssp. Sinensis (Miq.) P. D. Sell, Cunninghamia lanceolata (Lamb.) Hook., Sciadopytis verticillata (Thunb.) Sieb. & Zucc., Sciadopytis verticillata, T. distichum, T. distichum var. umbricatum);

Sequdiadendron (e.g. S. sempervirens (Lambert) Endl., S. giganteum (Lindl.) Buchh.) and Masequoia (e.g. Metasquoia glyptostroboides Hu & Cheng).

Furthermore it is especially useful for controlling wilding conifer plants belonging to the family of Araucariaceae belonging to the genus of Araucaria (e.g. A. araucana and A. excelsa).

Furthermore it is especially useful for controlling wildling conifer plants belonging to the family of Taxaceae belonging to the genus of Taxus (e.g. T. baccata L., T. cuspidata, T. x media, T. californica and Torreya nucifera).

The method according to the present invention is suitable for controlling naturally seeded coniferous plants, in particular wildling plants belonging to the family of Pinaceae. It is especially useful for controlling wildling conifer plants belonging to the genus of pinus, in particular those of the subgenera P. australes, P. contortae, P. strobi and P. sylvestres, e.g. wildlings of the species P. banksiana, P. clausa, P. contorta, P. echinata, P. elliottii, P. glabra, P. lambertina, P. palustris, P. ponderosa, P. pungens, P. resinosa,P. rigida, P. serotina, P. strobus, P. taeda or P. virginiana. The method of the invention is particularly useful for controlling the pine species P. banksiana, P. contorta, P. echinata, P. elliottii, P. lambertina, P. palustris, P. ponderosa, P. rigida, P. strobus, P. taeda and P. virginiana.

The method according to the present invention is also useful for controlling other undesirable vegetation in forestry, in particular a range of woody species such as Liquidamber styraciflua, Quercus ssp., Acer ssp., Carya ssp., Rhus ssp., Rubus ssp., etc., and herbaceous weeds such as Amaranthus spp., lpomoea ssp. (e.g. lpomoea lacunosa, lpomoea hederacea), Ambrosia artemisiifolia, Solanum ptycanthum, Campsis radicans, Conyza canadensis, etc.

Thereby, planting of conifer seedlings as well as its growth is facilitated.

The method according to the present invention can also be used for controlling wildling conifer plants and/to other undesirable vegetation in forestry, wherein the coniferous plants are resistant to one ore more herbicides owing to genetic engineering and/or breeding, or are resistant to attack by insects owing to genetic engineering and/or breeding.

Suitable are e.g. coniferous plants which are resistant to e.g. herbicidal EPSP synthase inhibitors, such as, e.g. glyphosate; herbicidal glutamine synthase inhibitors, such as, e.g. glufosinate; herbicidal ALS inhibitors, such as, e.g. imazamethabenz, imazamox, imazapic, imazapyr, imazaquin, imazethapyr; herbicidal auxin herbicides such as e.g. triclopyr;

or coniferous plants which owing to genetic engineering and/or breeding are resistant to attack by certain insects (e.g. southern pine beetle), e.g. plants which owing to introduction of the gene for Bt toxin by generic modification are resistant to attack by certain insects (e.g. pine tip moth).

Preferably, the phenyluracil of formula I and optionally the herbicide B are applied during site-preparation, i.e. before the conifer seedlings are planted. However it is also possible to apply the phenyluracil of formula I and optionally the herbicide B in conifer plantations, i.e. in the presence of planted conifer seedlings or trees. In this case, the phenyluracil of formula I and optionally the herbicide B are preferably applied by directed treatment of the wildings in order to leave the planted seedlings or trees unaffected.

Preferably the phenyluracil of formula I and optionally the herbicide B are applied in the site-preparation of pine plantations, and especially the site-preparation for plantations of pine species selected from P. banksiana, P. clausa, P. contorta, P. echinata, P. elliottii, P. glabra, P. lambertina, P. palustris, P. ponderosa, P. pungens, P. resinosa, P. rigida, P. serotina, P. strobus, P. taeda or P. virginiana.

In particular, the method of the invention comprises at least one application of the phenyluracil of formula I and optionally the herbicide B within 1 year and especially preferred within 10 months prior to planting of the conifer seedlings. More preferably the phenyluracil of formula I and optionally the herbicide B are applied within the period from 3 to 10 month and especially preferred from 6 to 10 months prior to planting of the conifer seedlings. However, it is also possible to apply the phenyluracil of formula I and optionally the herbicide B shortly before or up to the day when the conifer seedlings are planted.

Preferably the phenyluracil of formula I and optionally the herbicide B are applied in spring, summer or fall, more preferably from the beginning of May until the end of October in the northern hemisphere or from beginning of September until the end of February in the southern hemisphere.

The application of the phenyluracil of formula I and optionally the herbicide B can be repeated once, twice or more often until the conifer seedlings are planted. The periods between each application may vary from 0,5 month to 6 month. However, generally one application is sufficient. In case of several applications it is preferable that the total application rate of all applications does not exceed the above given maximum application rates.

Depending on the form in which the ready-to-use preparations are present in the compositions according to the invention, they comprise one or more liquid or solid carriers, if appropriate, surfactants and, if appropriate, further auxiliaries which are customary for formulating crop protection products. The person skilled in the art is sufficiently familiar with the recipes for such formulations.

Suitable inert auxiliaries with carrier function are e.g.:
liquid carriers such as mineral oil fractions with a medium to high boiling point, such as kerosene and diesel oil, furthermore coal tar oils and oils of vegetable or animal origin, aliphatic, cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water, and
solid carriers such as mineral earths e.g. silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

Suitable auxiliaries comprise any auxiliaries which are usually employed in formulations of herbicides, e.g. tackifiers, anti-oxidants, preservatives, rheology modifiers such as thickeners, anti-freezes, defoamers and surface active substances, as well as leaf surface penetrants, wetters, stickers and spreaders.

The latter comprise emulsifiers, protective colloids, wetting agents, anti-settling agents and dispersants that are normally employed in agricultural formulations of herbicides. The surface-active substances may be nonionic, anionic and/or cationic. Suitable surfactants which may be used in the compositions of the invention are disclosed e. g. in “McCutcheon's Detergents and Emulsifiers Annual”, MC Publishing Corp., Ridgewood, N.J., USA 1981; H. Stache, “Tensid-Taschenbuch”, 2^{nd} ed., C. Hanser, Munich, Vienna, 1981; M. and J. Ash, “Encyclopedia of Surfactants”, vol. I-III, Chemical Publishing Co., New York, N.Y., USA 1980-1981. Suitable surfactants are e.g. the alkali metal salts, alkaline earth metal salts and ammonium salts of aromatic sulfonic acids, e.g. ligno-, phenol-, naphthalene- and dibutylnaphthalenesulfonic acid, and of fatty acids, of alkyl- and alkylarylsulfonates, of alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ether, tributylphenyl polyglycol ether, alkylaryl polyether alcohols, isotridecyl alcohol, fatty alcohol/ethylene oxide condensates, ethoxylated castor oil, polyoxyethylene alkyl ether or polyoxypropylene alkyl ether, lauryl alcohol polyglycol ether acetate, sorbitol esters, lignosulfite waste liquors or methylcellulose.

Suitable thickening agents include inorganic thickening agents, such as clays, hydrated magnesium silicates and organic thickening agents, such as polysaccharide gums, like xanthan gum, guar gum, gum arabic and cellulose derivatives. Suitable preservatives to prevent microbial spoiling of the compositions of the invention include formaldehyde, alkyl esters of p-hydroxybenzoic acid, sodium benzoate, 2-bromo-2-nitropropane-1,3-diol, o-phenylphenol, thiazolinones, such as benzisothiazolinone, 5-chloro-2-methyl-4-isothiazolinone, pentachlorophenol, 2,4-dichlorobenzyl alcohol and mixtures thereof. Suitable anti-freezing agents include organic solvents which are completely miscible with water, such as ethylene glycol, propylene glycol, other glycols, glycerin or urea. Suitable defoamers include polysiloxanes, such as polydimethyl siloxane.

Aqueous use forms of the phenyluracil of formula I and optionally the herbicide B can be prepared from emulsion concentrates, suspensions, pastes, wettable powders or water-dispersible granules by adding water. To prepare emulsions, pastes or oil dispersions, the phenyluracil of formula I and optionally the herbicide B, both as such or dissolved in an oil or solvent, can be homogenized in water by means of a wetting agent, tackifier, dispersant or emulsifier. Alternatively, it is also possible to prepare concentrates comprising the active substance, wetting agent, tackifier, dispersant or emulsifier and, if desired, solvent or oil, and these concentrates are suitable for dilution with water.

Powders, materials for spreading and dusts can be prepared by mixing or concomitantly grinding the active substances with a solid carrier.

Granules, e.g. coated granules, impregnated granules and homogeneous granules, can be prepared by binding the active compounds to solid carriers.

The concentrations of the active compounds in the ready-to-use preparations can be varied within wide ranges. In general, the compositions of the invention comprise approximately from 0.001 to 98% by weight, preferably 0.01 to 95% by weight, of active compounds. The active compounds are employed in a purity ranging from 90% to 100%, preferably 95% to 100% (according to NMR spectrum).

The compositions according to the invention can, for example, be formulated as follows:

I 20 parts by weight of the active compound or active compound mixture in question are dissolved in a mixture composed of 80 parts by weight of alkylated benzene, 10 parts by weight of the adduct of 8 to 10 mol of ethylene oxide to 1 mol of oleic acid N-monoethanolamide, 5 parts by weight of calcium dodecylbenzenesulfonate and 5 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active compound.

II 20 parts by weight of the active compound or active compound mixture in question are dissolved in a mixture composed of 40 parts by weight of cyclohexanone, 30 parts by weight of isobutanol, 20 parts by weight of the adduct of 7 mol of ethylene oxide to I mol of isooctylphenol and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active compound.

III 20 parts by weight of the active compound or active compound mixture in question are dissolved in a mixture composed of 25 parts by weight of cyclohexanone, 65 parts by weight of a mineral oil fraction with a boiling point of 210 to 280° C. and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active compound.

IV 20 parts by weight of the active compound or active compound mixture in question are mixed thoroughly with 3 parts by weight of sodium diisobutyinaphthalenesulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20 000 parts by weight of water gives a spray mixture which comprises 0.1% by weight of the active compound.

V 3 parts by weight of the active compound or active compound mixture in question are mixed with 97 parts by weight of finely divided kaolin. This gives a dust which comprises 3% by weight of the active compound.

VI 20 parts by weight of the active compound or active compound mixture in question are mixed intimately with 2 parts by weight of calcium dodecylbenzenesulfonate, 8 parts by weight of fatty alcohol polyglycol ether, 2 parts by weight of the sodium salt of a phenol-urea-formaldehyde condensate and 68 parts by weight of a paraffinic mineral oil. This gives a stable oily dispersion.

VII 1 part by weight of the active compound or active compound mixture in question is dissolved in a mixture composed of 70 parts by weight of cyclohexanone, 20 parts by weight of ethoxylated isooctylphenol and 10 parts by weight of ethoxylated castor oil. This gives a stable emulsion concentrate.

VIII 1 part by weight of the active compound or active compound mixture in question is dissolved in a mixture composed of 80 parts by weight of cyclohexanone and 20 parts by weight of Wettol® EM 31 (nonionic emulsifier based on ethoxylated castor oil). This gives a stable emulsion concentrate.

Moreover, it may be useful to apply the phenyluracil of formula I and optionally the herbicide B according to the invention jointly as a mixture with other crop protection products, for example with pesticides or agents for controlling phytopathogenic fungi or bacteria. Also of interest is the miscibility with mineral salt solutions which are employed for treating nutritional and trace element deficiencies. Non-phytotoxic oils and oil concentrates may also be added.

The invention is further illustrated by the following greenhouse and field examples, which demonstrate the effect of the method according to the invention on the growth of wildling conifer, in particular wildling pine (Pinus spp.).

1. Greenhouse Experiments

### EXAMPLE 1

For the following experiment the phenyluracil of formula I and optionally the herbicide B were applied as an aqueous spray liquor. Phenyluracil I.1.4 (phenyluracil of formula I) was used as an emulsifiable concentrate (0.120 kg a.i./L). Imazapyr (herbicide B) was used as an emulsifiable concentrate (26.7% by weight; Chopper®/BASF Corporation). Methylated seed oil (MSO) was also added to the spray liquor in amounts of 1 % volume/volume as a standard spray adjuvant. Water was used as the carrier. Spray carrier volume was 187 L/ha.

The spray liquor had the following general recipe (based on a spray volume of 187 L/ha):

| | |
|---|---|
| phenyluracil I.1.4 | 12.5 ml/L (0.280 kg a.i./ha) |
| imazapyr | 18.0 ml/L (0.840 kg a.i./ha) |
| MSO | 10.0 ml/L (1.0% v/v) |

Wildling pine of the variety Loblolly (Pinus taeda L.) were first grown to a height of 50 to 60 cm (one year old seedlings) and then postemergence herbicide applications were made. Here, the herbicidal compositions were suspended or emulsified in water as distribution medium to obtain a spray liquor, which was sprayed on the wildlings by using finely distributing nozzles, e.g. even flat fan spray nozzles. The experiment was set up as a completely random design with four replications (one seedling per replication).

The test period extended over 42 days at 27° C. During this time, the plants were tended, and their response to the treatments with the active compound was evaluated.

The evaluation for the damage caused by the chemical compositions was carried out using a scale from 0 to 100%, compared to the untreated control plants. Here, 0 means no damage and 100 means complete destruction of the plants. The results are presented in table 3.

TABLE 3

| | Rate | Loblolly pine |
|---|---|---|
| Treatment | [kg a.i./ha] | control* [%] |
| control | — | 0 |
| phenyluracil I.1.4 + imazapyr + MSO | 0.280 + 0.840 | 96 |
| imazapyr + MSO | 0.840 | 0 |

*means of four replications

The data in table 3 show that phenyluracil I.1.4+imazapyr provided excellent control of the Loblolly pine seedlings.

### EXAMPLE 2

For the following experiment the phenyluracil of formula I and optionally the herbicide B were applied as an aqueous spray liquor. Phenyluracil 1.1.4 (phenyluracil of formula I) was used as an emulsifiable concentrate (0.120 kg a.i./L). Imazapyr (herbicide B) was used as an emulsifiable concentrate (26.7% by weight; Chopper®/BASF Corporation). Methylated seed oil (MSO) was also added to the spray liquor in amounts of 6% volume/volume as a standard spray adjuvant. Water was used as the carrier. Spray carrier volume was 200 L/ha.

The spray liquor had the following general recipe (based on a spray volume of 200 L/ha):

| | |
|---|---|
| phenyluracil I.1.4 | 6.0 ml/L (0.140 kg a.i./ha) |
| | 12.0 ml/L (0.280 kg a.i./ha) |
| imazapyr | 18.0 ml/L (0.840 kg a.i./ha) |
| MSO | 60.0 ml/L (6.0% v/v) |

Wildling pine of the variety Loblolly (Pinus taeda L.) were first grown to a height of 30 to 40 cm (one year old seedlings) and then postemergence herbicide applications were made. Here, the herbicidal compositions were suspended or emulsified in water as distribution medium to obtain a spray liquor, which was sprayed on the wildlings by using finely distributing nozzles, e.g. even flat fan spray nozzles. The experiment was set up as a completely random design with four replications (one seedling per replication).

The test period extended over 28 days at 27° C. During this time, the plants were tended, and their response to the treatments with the active compound was evaluated.

The evaluation for the damage caused by the chemical compositions was carried out using a scale from 0 to 100%, compared to the untreated control plants. Here, 0 means no damage and 100 means complete destruction of the plants. The results are presented in table 4.

TABLE 4

| | Rate | Loblolly pine |
|---|---|---|
| Treatment | [kg a.i./ha] | control* [%] |
| control | — | 0 |
| phenyluracil I.1.4 + MSO | 0.140 | 80 |
| phenyluracil I.1.4 + MSO | 0.280 | 88 |
| phenyluracil I.1.4 + imazapyr + MSO | 0.140 + 0.840 | 96 |
| phenyluracil I.1.4 + imazapyr + MSO | 0.280 + 0.840 | 97 |

*means of three replications

The data in table 4 show that phenyluracil I.1.4 provided good to excellent control of the Loblolly pine seedlings applied solo or in combination with imazapyr.

2. Field Experiments

Site 1

For the following experiment the phenyluracil of formula I and optionally the herbicide B were applied as an aqueous spray liquor.

Phenyluracil I.1.4 (phenyluracil of formula I) was used as an emulsifiable concentrate (0.120 kg a.i./ L). Imazapyr (herbicide B) was used as an emulsifiable concentrate (26.7% by weight; Chopper®/BASF Corporation). Glyphosate (herbicide B) was used as a soluble concentrate (53.8% by weight; Accord® Concentrate/Dow AgroScience) Methylated seed oil (MSO) was also added to the spray liquor in amounts of 12.5% volume/volume as a standard spray adjuvant. Water was used as the carrier. Spray carrier volume was 187 L/ha.

The spray liquor had the following general recipe (based on a spray volume of 187 L/ha):

| | |
|---|---|
| phenyluracil I.1.4 | 6.25 ml/L (0.140 kg a.i./ha) |
| | 12.5 ml/L (0.280 kg a.i./ha) |
| imazapyr | 12.5 ml/L (0.560 kg a.i./ha) |
| glyphosate | 18.75 ml/L (1.70 kg a.i./ha) |
| MSO | 125.0 ml/L (12.5% v/v) |

The test site selected consisted of a population of wildling pine of the variety Loblolly (Pinus taeda) that were allowed to grow to a height of 60 to 150 cm (2 yr old seedlings) and then treated. Here, the herbicidal compositions were suspended or emulsified in water as the distribution medium and sprayed using finely distributing nozzles, e.g. flat fan spray nozzles. Experiment design used was a randomized complete block design with three replications (5 seedlings per replication).

The test period extended over 276 days. During this time, response to the treatments with the active compound was evaluated.

The evaluation for the damage caused by the chemical compositions was carried out using a scale from 0 to 100%, compared to the untreated control plants. Here, 0 means no damage and 100 means complete destruction of the plants. The results are presented in table 5.

TABLE 5

| | Rate | Loblolly pine |
|---|---|---|
| Treatment | [kg a.i./ha] | control* [%] |
| control | — | 0 |
| phenyluracil I.1.4 + MSO | 0.140 | 73 |
| phenyluracil I.1.4 + MSO | 0.280 | 97 |
| phenyluracil I.1.4 + imazapyr + MSO | 0.140 + 0.560 | 77 |
| phenyluracil I.1.4 + imazapyr + MSO | 0.280 + 0.560 | 98 |
| glyphosate + MSO | 1.70 | 73 |
| phenyluracil I.1.4 + glyphosate + MSO | 0.140 +1.70 | 100 |

*means of three replications, ratings at 276 days after treatment

The results presented in table 5 confirmed greenhouse results of the susceptibility of wilding pine to applications of phenyluracil I.1.4 applied solo or in combinations with other activities (i.e. imazapyr and glyphosate).

Site 2

For the following experiment the phenyluracil of formula I and optionally the herbicide B were applied as an aqueous spray liquor. Phenyluracil I.1.4 (phenyluracil of formula I) was used as emulsifiable concentrate (0.120 kg a.i./L). Imazapyr (herbicide B) was used as an emulsifiable concentrate (26.7% by weight; Chopper®/BASF Corporation). Glyphosate (herbicide B) was used as a soluble concentrate (53.8% by weight; Accord® Concentrate/Dow AgroScience) Methylated seed oil (MSO) was also added to the spray liquor in amounts of 25.0% volume/volume as a standard spray adjuvant. Water was used as the carrier. Spray carrier volume was 65 L/ha.

The spray liquor had the following general recipe (based on a spray volume of 65 L/ha):

| | |
|---|---|
| phenyluracil I.1.4 | 36.0 ml/L (0.280 kg a.i./ha) |
| | 72.0 ml/L (0.560 kg a.i./ha) |
| imazapyr | 56.0 ml/L (0.840 kg a.i./ha) |
| glyphosate | 64.0 ml/L (2.70 kg a.i./ha) |
| MSO | 250.0 ml/L (25.0% v/v) |

Herbicide treatments were applied in the spring using a pole sprayer with a single KLC-9 flood tip spraying from a height of 335 cm. This application technique was used to simulate operational aerial applications as closely as practical. Treatment plots were 9×18 m.

Woody vegetation was assessed at treatment and in the fall of the year of treatment and one year after treatment (one and two growing seasons after treatment). The most common woody species on the site at treatment included loblolly pine (Pinus taeda), southern red oak (Quercus falcata), water oak (Quercus nigra) and Vaccinium spp. Minor species included black cherry (Prunus serotina), sassafras (Sassafras albidum), persimmon (Diospyros virginiana), black tupelo (Nyssa sylvatica) and winged sumac (Rhus copallinum). Pines ranged in size from 18 to 180 cm.

The evaluation for the browning caused by the chemical compositions was carried out using a scale from 0 to 100%, compared to the untreated control plants. Here, 0 means no necrosis and 100 means complete tissue necrosis. The results are presented in table 6.

TABLE 6
Percent brownout of pine species following May application

| | | Weeks after treatment | | | | |
|---|---|---|---|---|---|---|
| | | (WAT) | | | | |
| | Rate | 1 | 2 | 4 | 6 | 8 |
| Treatments | [kg a.i./ha] | brownout [%] | | | | |
| control | — | 0 | 0 | 0 | 0 | 0 |
| imazapyr + MSO | 0.840 | 2 | 5 | 30 | 40 | 40 |
| imazapyr + glyphosate + MSO | 0.840 + 2.7 | 20 | 25 | 40 | 50 | 70 |
| phenyuracil I.1.4 + imazapyr + | 0.280 + 0.840 | 80 | 90 | 95 | 97 | 97 |
| MSO | | | | | | |
| phenyuracil I.1.4 + imazapyr + | 0.560 + 0.840 | 90 | 95 | 95 | 98 | 98 |
| MSO | | | | | | |

The results presented in table 6 show that both Phenyluracil compounds resulted in rapid browning of pines and other hardwood species.

At 1 WAT browning was 2% for straight imazapyr, 20% for imazapyr+glyphosate and 80-90% for phenyluracil I.1.4+imazapyr. By 8 WAT, brownout was greater than 97% for the Phenyluracil I.1.4 tank mixes.

Site 3

For the following experiment the phenyluracil of formula I and optionally the herbicide B were applied as an aqueous spray liquor. Phenyluracil I.1.4 (phenyluracil of formula I) was used as emulsifiable concentrate (0.120 kg/L). Imazapyr (Herbicide B) was used as an emulsifiable concentrate (26.7% by weight; Chopper®/BASF Corporation). Glyphosate was used as a soluble concentrate (53.8% by weight; Accord® Concentrate/Dow AgroScience). One treatment was applied with a non-ionic surfactant (NIS) at a rate of 0.25% by volume/volume. The remaining treatments were applied in an oil emulsion carrier containing methylated seed oil (MSO) at a rate of 25.0% volume/volume. Water was used as the carrier. Spray carrier volume was 140 L/ha.

The spray liquor had the following general recipe (based on a spray volume of 140 L/ha):

| | |
|---|---|
| phenyluracil I.1.4 | 16.0 (0.280 kg a.i./ha) |
| | 32.0 ml/L (0.560 kg a.i./ha) |
| imazapyr | 25.0 ml/L (0.840 kg a.i./ha) |
| glyphosate | 30.0 ml/L (1.70 kg a.i./ha) |
| NIS | 2.5 ml/L (0.25% v/v) |
| MSO | 250.0 ml/L (25.0% v/v) |

Herbicide treatments were applied in the fall of the year using a pole sprayer with a single KLC-9 flood tip spraying from a height of 335 cm. Treatment plots were 7.6×23 m.

Woody vegetation was assessed at treatment and one growing season after treatment. Brownout of pine species was assessed at 1, 4 and 12 weeks after treatment (WAT) and 6 months after treatment. Dominant vegetation at treatment included ragweed (1.8 m), sweetgum resprouts (1.2 m), oak resprouts (0.3 m) and pine seedlings (12 to 30 cm).

The evaluation for the browning caused by the chemical compositions was carried out using a scale from 0 to 100%, compared to the untreated control plants. Here, 0 means no necrosis and 100 means complete tissue necrosis. The results are shown in table 7.

TABLE 7
Percent brownout of pine species following September application.

| | | Weeks after | | | |
|---|---|---|---|---|---|
| | | treatment | | | |
| | | (WAT) | | | |
| | Rate | 1 | 4 | 12 | 6 |
| Treatments | [kg a.i./ha] | brownout [%] | | | month |
| control | — | 0 | 0 | 0 | 0 |
| imazapyr + MSO | 0.840 | 0 | 5 | 0 | 25 |
| imazapyr + glyphosate + | 0.840 + 1.70 | 5 | 70 | 100 | 100 |
| MSO | | | | | |
| phenyluracil I.1.4 + | 0.140 + 0.840 | 35 | 80 | 90 | 70 |
| imazapyr + MSO | | | | | |
| phenyluracil I.1.4 + | 0.280 + 0.840 | 45 | 90 | 100 | 100 |
| imazapyr + MSO | | | | | |

The results presented in table 7 prove that 0.280 kg a.i./ha phenyluracil I.1.4+0.840 kg a.i./ha imazapyr+MSO controlled 100% of the pines. There was a rate response for phenyluracil I.1.4+0.840 kg a.i./ha imazapyr+MSO: Increasing phenyluracil I.1.4 rate from 0.140 to 0.280 kg a.i./ha increased pine control from 70 to 100%.

Site4

For the following experiment the phenyluracil of formula I and optionally the herbicide B were applied as an aqueous spray liquor. Phenyluracil I.1.4 (phenyluracil of formula I) was used as an emulsifiable concentrate (0.120 kg a.i./ L). Imazapyr (herbicide B) was used as an emulsifiable concentrate (53.1% by weight; Arsenal AC ®/BASF Corporation). Dicamba (herbicide B) was used as a soluble liquid (26.7% by weight; Clarity ®/BASF Corporation). Methylated seed oil (MSO) was also added to the spray liquor in amounts of 6.25% volume/volume (v/v) as a standard spray adjuvant. Water was used as the carrier. Spray carrier volume was 187 L/ha.

The spray liquor had the following general recipe (based on spray volume of 187 L/ha):

| | |
|---|---|
| phenyluracil I.1.4 | 6.25 ml/L (0. 14 kg a.i./ha) |
| imazapyr | 12.5 ml/L (0. 56 kg a.i./ha) |
| dicamba | 25.0 ml/L (2.20 kg a.i./ha) |
| MSO | 62.50 ml/L (6.25% v/v) |

The test site selected consisted of a population of wildling pine of the variety Loblolly (Pinus taeda) that were allowed to grow to a height of 60 to 150 cm (2 yr old seedlings) and then treated. Here, the herbicidal compositions were suspended or emulsified in water as the distribution medium and sprayed using finely distributing nozzles, e.g. flat fan spray nozzles. Experiment design used was a randomized complete block design with three replications (5 seedlings per replication).

The test period extended over 184 days. During this time, response to the treatments with the active compound was evaluated.

The evaluation for the damage caused by the chemical compositions was carried out using a scale from 0 to 100%, compared to the untreated control plants. Here, 0 means no damage and 100 means complete destruction of the plants. The results are presented in table 8.

TABLE 8

| | Rate | Loblolly pine |
|---|---|---|
| Treatment | [kg a.i./ha] | control* [%] |
| control | — | 0 |
| phenyluracil I.1.4 + imazapyr | 0.140 + 0.560 | 87 |
| phenyluracil I.1.4 + imazapyr + | 0.140 + 0.560 + 2.20 | 100 |
| dicamba | | |

*means of three replications, ratings at 184 days after treatment

The results presented in table 8 showed that the addition of dicamba improved the control of wildling pine when combined with phenyluracil I.1.4.

1. A method for controlling coniferous plants, wherein an effective amount of
a) at least one phenyluracil of the formula I 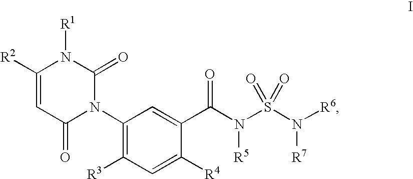
wherein the variables R¹ to R⁷ are as defined below:
R¹ is methyl or NH₂;
R² is C₁-C₂-haloalkyl;
R³ is hydrogen or halogen;
R⁴ is halogen or cyano;
R⁵ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or C₁-C₆-alkyl;
R⁶, R⁷ independently of one another are hydrogen, C₁-C₆-alkyl, C₃-C₆-alkenyl, C₃-C₆-alkynyl, C₃-C₇-cycloalkyl, C₃-C₇-cycloalkenyl, C₁-C6-alkoxy, phenyl or benzyl, where each of the 8 abovementioned substituents is unsubstituted or may be substituted by 1 to 6 halogen atoms and/or by one, two or three radicals selected from the group consisting of cyano, C₃-C₇-cycloalkyl, hydroxy, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, amino, C₁-C₄-alkylamino, di(C₁-C₄-alkyl)amino, formyl, C₁-C₄-alkylcarbonyl, C₁-C₄-alkoxycarbonyl, aminocarbonyl, C₁-C₄-alkylaminocarbonyl, di(C₁-C₄-alkyl)aminocarbonyl, phenyl and benzyl; or
R⁶, R⁷ together with the nitrogen atom to which they are attached form a 3-, 4-, 5-, 6- or 7-membered saturated or unsaturated nitrogen containing heterocycle which may be substituted by 1 to 6 methyl groups and which may contain 1 or 2 further heteroatoms selected from the group consisting of nitrogen, oxygen and sulfur as ring members;
and/or at least one agriculturally acceptable salt thereof ; and optionally
b) at least one herbicide B selected from groups B1 to B6:
B1 acetolactate synthase inhibitors (ALS inhibitors);
B2 photosynthesis inhibitors;
B3 enolpyruvyl shikimate 3-phosphate synthase inhibitors (EPSP inhibitors);
B4 glutamine synthetase inhibitors;
B5 auxin herbicides;
B6 other herbicides: fosamine;
and/or at least one agriculturally acceptable salts of herbicide B or an agriculturally acceptable derivatives thereof, provided that they have a carboxyl group;
is applied to coniferous plants to be controlled and/or to the parts of these plants.

2. The method as claimed in claim 1, wherein the phenyluracil of formula I and herbicide B are applied in a weight ratio
I:B ranging from
200:1 to 1:200.

3. The method as claimed in claim 1, wherein the phenyluracil of formula I is applied in an amount of from 0.010 kg a.i./ha to 1.50 kg a.i./ha.

4. The method as claimed in claim 2, wherein the herbicide B is applied in an amount of from 0.010 kg a.i./ha to 10.00 kg a.i./ha.

5. The method as claimed in claim 1, wherein the effective amount of phenyluracil of formula I and optionally herbicide B is applied during site preparation for a plantation of coniferous trees.

6. The method as claimed in claim 1, wherein the effective amount of phenyluracil of formula I and optionally herbicide B is applied after emergence of the coniferous plants to be controlled.

7. The method as claimed in claim 1, wherein the coniferous plants to be controlled belong to the Pinaceae family.

8. The method as claimed in claim 1, wherein the coniferous plants to be controlled are selected from the pine species consisting of P. banksiana, P. clausa, P. contorta, P. echinata, P. elliotti, P. glabra, P. lambertina, P. palustris, P. ponderosa, P. pungens, P. resinosa, P. rigida, P. serotina, P. strobus, P. taeda and P. virginiana.

9. The method as claimed in claim 1 for controlling wildling coniferous plants and/or undesirable vegetation in forestry, where the coniferous plants are resistant to at least one ore more herbicide owing to genetic engineering and/or breeding.

10. The method as claimed in claim 1 for controlling wildling coniferous plants and/or undesirable vegetation in forestry, where the coniferous plants are resistant to attack by insects owing to genetic engineering and/or breeding.

11. The method of claim 1, wherein the undesired coniferous plants to be controlled are growing in a pine plantation, or in an area of site-preparation for a pine plantation.

12. The method of claim 1, wherein the phenyluracil of formula I has the following radicals:
R¹ is methyl or NH₂;
R² is trifluoromethyl;
R³ is hydrogen, fluorine or chlorine,
R⁴ is halogen or cyano,
R⁵ is hydrogen;
R⁶, R⁷ independently of one another are hydrogen, C₁-C₆-alkyl, C₃-C₆-alkenyl, C₃-C₆-alkynyl, C₃-C₇-cycloalkyl, C₃-C₇-cycloalkenyl, phenyl or benzyl, or
together with the nitrogen atom form a pyrrolidine, piperidine, morpholine, N-methylpiperazine or perhydroazepine ring.

13. The method of claim 12, wherein
R³ is fluorine;
R⁴ is chlorine; and
R⁶ and R⁷ are independently each a C₁-C₆- alkyl radical.

14. The method of claim 1, wherein at least one herbicide B is used, wherein the herbicide B is selected from groups B1, B3, B4, B5 and B6.

15. The method of claim 14, wherein the herbicide B is selected from Groups B1, B3 and B4.

16. The method of claim 1, wherein the phenyluracil is of the formula I.1 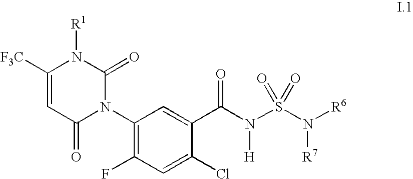
where R¹, R⁶ and R⁷ are as defined in claim 1, and the herbicide B is selected from the group consisting of metsulfuron, sulfometuron, imazapyr, hexazione, paraquat, glyphosate, glufosinate, 2,4-D, dicamba, aminopyralid, clopyralid, picloram, triclopyr and fosamine.

17. A kit comprising, in separate containers
(a) at least one phenyluracil of the formula I 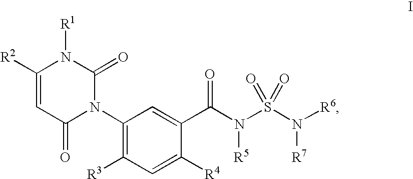
wherein the variables R¹ to R⁷ are as defined below:
R¹ is methyl or NH₂;
R² is C₁-C₂-haloalkyl;
R³ is hydrogen or halogen;
R⁴ is halogen or cyano;
R⁵ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or C₁-C₆-alkyl;
R⁶, R⁷ independently of one another are hydrogen, C₁-C₆-alkyl, C₃-C₆-alkenyl, C₃-C₆-alkynyl, C₃-C₇-cycloalkyl, C₃-C₇-cycloalkenyl, C₁-C6-alkoxy, phenyl or benzyl, where each of the 8 abovementioned substituents is unsubstituted or may be substituted by 1 to 6 halogen atoms and/or by one, two or three radicals selected from the group consisting of cyano, C₃-C₇-cycloalkyl, hydroxy, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, amino, C₁-C₄-alkylamino, di(C₁-C₄-alkyl)amino, formyl, C₁-C₄-alkylcarbonyl, C₁-C₄-alkoxycarbonyl, aminocarbonyl, C₁-C₄-alkylaminocarbonyl, di(C₁-C₄-alkyl)aminocarbonyl, phenyl and benzyl; or
R⁶, R⁷ together with the nitrogen atom to which they are attached form a 3-, 4-, 5-, 6- or 7-membered saturated or unsaturated nitrogen containing heterocycle which may be substituted by 1 to 6 methyl groups and which may contain 1 or 2 further heteroatoms selected from the group consisting of nitrogen, oxygen and sulfur as ring members;
and/or at least one agriculturally acceptable salt thereof; and
(b) at least one herbicide B selected from groups B1 to B6:
B1 acetolactate synthase inhibitors (ALS inhibitors);
B2 photosynthesis inhibitors;
B3 enolpyruvyl shikimate 3-phosphate synthase inhibitors (EPSP inhibitors);
B4 glutamine synthetase inhibitors;
B5 auxin herbicides;
B6 other herbicides: fosamine;
and/or at least one agriculturally acceptable salt of herbicide B or an agriculturally acceptable derivative thereof, provided they have a carboxyl group.

18. The method of claim 11, wherein the coniferous plants to be controlled are wildling conifers which belong to the Pinaceae family.
